(19) United States
(12) Patent Application Publication
(10) Pub. No.: US 2021/0307365 A1
(43) Pub. Date: Oct. 7, 2021

(54) ENCAPSULATION OF NUTRITIONAL AND/OR COMPOUNDS FOR CONTROLLED RELEASE AND ENHANCING THEIR BIOAVAILABILITY BY LIMITING CHEMICAL OR MICROBIAL EXPOSURE

(71) Applicants: North Carolina State University, Raleigh, NC (US); Jefo Nutrition, Inc., Saint-Hyacinthe (CA)

(72) Inventors: Peter R. Ferket, Raleigh, NC (US); Jean Fontaine, Saint-Hyacinthe (CA); Jean-Daniel Bunod, Bromont (CA)

(21) Appl. No.: 16/347,305

(22) PCT Filed: Nov. 8, 2017
(86) PCT No.: PCT/US2017/060667

§ 371 Date: May 3, 2019

Related U.S. Application Data
(60) Provisional application No. 62/419,218, filed on Nov. 8, 2016.

(51) Int. Cl. A23K 40/30; A23K 20/142; A23K 20/158; A23K 20/174; A23K 20/22; A23K 20/24; A23K 50/75

(52) U.S. Cl. CPC A23K 40/30; A23K 20/142; A23K 20/158; A23K 50/75; A23K 20/22; A23K 20/24; A23K 20/174

(57) ABSTRACT

Described are compositions comprising one or more nutrients encapsulated in a controlled release lipid matrix for feeding an animal.

### TECHNICAL FIELD

The present disclosure relates to a composition for feeding an animal comprising one or more nutrients encapsulated in a controlled release lipid matrix.

### BACKGROUND

The human and animal food industry demands nutritional supplements and feed additives that have the highest possible integrity, stability, and bioavailability. However, manufacturers of nutritional supplements, additives, food, and animal feeds are fraught with processing challenges caused by the inherently sensitive nature of bioactive substances or ingredients. Undesirable reactions of these bioactive compounds when combined or exposed to the damaging effects of environmental conditions such as heat, oxygen, moisture, light, pH, enzymes, and microbial fermentation may occur, resulting in poor taste or smell, and/or reduced bioavailability of nutrients to the animal. In addition, some volatile or highly reactive bioactive compounds of significant value must be avoided entirely from feed formulations or products because of their organoleptic or chemical nature, thereby greatly limiting formulation effectiveness. Moreover, some volatile and unstable nutrients or components may be destroyed or neutralized before they reach the sites of the beneficial activities in the intestinal tract.

Nutritional and feed additive product manufacturers have tried to overcome the aforementioned limitations in a variety of ways. It is common practice to add extra excipients or carriers to minimize unfavorable ingredient interactions or improve handling and stability characteristics. However, these excipients take up valuable space in the feed formulations and only partially solve the problem as these excipients result in other organoleptic, physical, or chemical constraints.

Overdosing is another approach used to compensate for losses in stability or biological activity. However, this approach is also associated with a variety of negative effects. For example, overdosing may significantly increase formulation costs, is arguably wasteful and potentially harmful to the environment, and may negatively impact palatability or response predictability of the animal feed. In addition, nutrients in excess of the animal's daily requirement may become nutrients for the pathogenic flora in the gastro-intestinal tract. As such, improved means of protecting nutrients in animal feed compositions are needed.

### SUMMARY

Disclosed herein are compositions for feeding an animal. The compositions comprise a controlled release lipid matrix consisting of (a) at least one hydrogenated vegetable triglyceride selected from the group consisting of palm butter, sunflower oil, corn oil, rape oil, peanut oil and soybean oil; or (h) at least one animal triglyceride selected from the group consisting of bovine tallow and swine lard; and one or more nutrients encapsulated within the controlled release lipid matrix, wherein the one or more nutrients are selected from the group consisting of vitamins, amino acids, minerals, and combinations thereof. Further disclosed herein are methods for feeding an animal. The method may comprise mixing a disclosed composition with animal feed to form a supplemented animal feed, and orally administering the supplemented animal feed to the animal.

### BRIEF DESCRIPTIONS OF THE DRAWINGS

FIGS. 1A-B are bar graphs showing the effect of dietary treatment on body weight (BW; bars) and feed:gain ratio (FC; line) during (A) the starter phase (0-14 days of age) and (B) during the overall growth trial (0-31 days of age) of male broiler chickens.

FIG. 2 is a box plot distribution showing the effect of dietary treatment on body weight of male broiler chickens at 31 days of age.

FIG. 3 is a table showing the effects of dietary treatment on growth performance of male broiler chickens.

FIGS. 4A-B are box plots showing the effects of dietary treatment on body weight distribution of male broiler chickens at (A) 0 days and (B) 3:5 days of age.

FIGS. 5A-B are bar graphs showing the effect of dietary treatment on average daily growth (ADG; bars) and feed:gain ratio (FC; line) during the starter phase (0-14 days of age) and grower phase (14-28 days of age) of male broiler chickens.

FIG. 6 is a table showing the effect of dietary treatment on vitamin F serum concentrations collected from male broiler chickens at 21 and 35 days of age.

FIG. 7 is a bar graph showing the effect of dietary treatment on body weight (BW, bars) and feed:gain ratio (FC; line) from 0-28 days of age of male broiler chickens.

FIG. 8A-B are images showing (A) hydrogenated vegetable oil encapsulated vitamins and (B) hydrogenated vegetable oil encapsulated minerals.

FIGS. 9A-C are images showing the effect of dietary treatment on recovery from ammonia hawk burns. FIG. 9A shows an exemplary ammonia burn from the 100% free V+M group. FIG. 9B shows an exemplary ammonia burn from the 30% protected group. FIG. 9C shows an exemplary ammonia burn from the 30% free group.

FIGS. 10A-B are charts showing the effect of dietary treatment on moisture drip loss from meat collected from male broiler chickens. FIG. 10A shows drip loss over 5-7 days using the standard method. FIG. 10B shows drip lossover 5-7 days using the diaper wrap method.

### DETAILED DESCRIPTION

Encapsulation is a process whereby small particles of a bioactive substance are protected from their environment by enveloping them with a protective barrier coating material that may be comprised of a various lipids, carbohydrates, proteins, minerals, and alginates. The encapsulated ingredients can be designed to release the core bioactivities through a variety of mechanisms, depending on the environmental conditions or time/duration of release. For example, the coating materials selected specifically can be designed to dissolve slowly or quickly when a particular pH is reached, or when they are exposed to the complementary digestive enzymes and certain conditions within the digestive tract of an animal. Therefore, encapsulation enables an effective balance between protection and functional properties of a bioactive compound and thus improves its bioavailability.

Disclosed herein are compositions comprising encapsulated nutrients and methods for using the disclosed compositions for feeding an animal. By using the disclosed compositions, bioactive compounds are presented to the enteric ecosystem at more natural concentrations and release rates that are compatible with symbiotic microflora and the absorptive capacity and rates of the animal's enteric mucosa. As such, using the disclosed compositions to feed an animal avoids providing excessive amounts of nutrients to the animal that become readily available as substrates and nutrients for competing enteric microflora.

### 1. DEFINITIONS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s).” “having,” “has,” “can,” “contain(s)” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifier “about” used in connection with a quantity is inclusive of the stated value and has the meaning dictated by the context (for example, it includes at leak the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The terms feed:gain ratio, feed conversion ratio, EC, and FCR are used interchangeably herein to describe the ratio of feed consumed to the body weight of the animal.

### 2. COMPOSITIONS

Disclosed herein are compositions for feeding an animal. The composition may comprise a controlled release lipid matrix. The controlled release lipid matrix may consist of at least one hydrogenated vegetable triglyceride. The hydrogenated vegetable triglyceride may be palm butter, sunflower oil, corn oil, rape oil, peanut oil or soybean oil. The controlled release lipid matrix may consist of at least one animal triglyceride. The animal triglyceride may be bovine tallow or swine lard.

The composition may comprise one or more nutrients encapsulated within the controlled release matrix. Exemplary nutrients include vitamins, minerals, and amino acids. The composition may comprise any desirable combination of encapsulated vitamins, minerals, or amino acids. For example, the composition may comprise encapsulated vitamins, encapsulated minerals, and encapsulated amino acids. The composition may comprise encapsulated vitamins and encapsulated minerals. The composition may comprise encapsulated vitamins and encapsulated amino acids. The composition may comprise encapsulated minerals and encapsulated amino acids.

The composition may comprise one or more vitamins or vitamin precursors encapsulated within the controlled release matrix. For example, the composition may comprise vitamin A, vitamin E, vitamin D3, vitamin C, vitamin K, vitamin B1 (thiamin), vitamin B2 (riboflavin), vitamin B3 (niacin), choline, vitamin B5 (panthothenic acid), vitamin B6 (pyridoxine), biotin, inositol, vitamin B9 (folic acid), vitamin B10 (para amino benzoic acid), vitamin B 12 (cyano cobalamin), or beta-carotene. The composition may comprise any combination of the above listed vitamins and vitamin precursors.

The composition may comprise one or more minerals encapsulated within the controlled release matrix. For example, the composition may comprise cobalt, copper, selenium, iodine, iron, manganese, magnesium, sulfur, zinc, calcium, sodium, potassium, or phosphorus. The composition may comprise any combination of the above listed minerals.

The composition may comprise one or more amino acids encapsulated within the controlled release matrix. For example, the composition may comprise alanine, arginine, asparagine, aspartic acid, cysteine, glutamine, glutamic acid, glycine, histidine, isoleucine, lysine, methionine, phenylalanine, proline, serine, threonine, tryptophan, tyrosine, or valine. The composition may comprise any combination of the above listed amino acids.

### 3. METHODS

Further disclosed herein are methods for feeding an animal. The method may comprise mixing a disclosed composition with animal feed to form a supplemented animal feed, and administering the supplemented animal feed to the animal.

The supplemented animal feed may comprise any combination of encapsulated vitamins, minerals, and amino acids. The supplemented animal feed may comprise any amount of encapsulated nutrients sufficient to provide adequate nutrition to the animal. For example, the supplemented animal feed may contain encapsulated nutrients at 10-100% of the recommended daily amount for the animal. For example, the supplemented animal feed may contain encapsulated nutrients at 10-100%, 15-90%, 20-80%, 30-70%, 40-60%, or 50% of the recommended daily amount for the animal.

The supplemented animal feed may comprise one or more encapsulated vitamins. For example, the supplemented animal feed may comprise any one or more of vitamin A in an amount from about 3,000 to about 25,000 Ili per kg of the supplemented animal feed, vitamin D3 in an amount from about 1,000 to about 5,000 Ili per kg of the supplemented animal feed, vitamin E in an amount from about 1.5 to about 200 IU per kg of the supplemented animal feed, vitamin B1 (thiamin) in an amount from about 0.5 to about 5 mg per kg of the supplemented animal feed, vitamin B2 (riboflavin) in an amount from about 1.0 to about 20 mg per kg of the supplemented animal feed, vitamin B3 (niacin) in an amount from about 15 to about 150 mg per kg of the supplemented animal feed, choline in an amount from about 200 to about 2000 mg per kg of the supplemented animal feed, vitamin B5 (pantothenic acid) in an amount from about 5.0 to about 50 mg per kg of the supplemented animal feed, vitamin B6 (pyroxidone) in an amount from about 0.5 to about 10.0 mg per kg of the supplemented animal feed, biotin in an amount from about 0.05 to about 1.0 mg per kg of the supplemented animal feed, inositol in an amount from about 500 mg per kg to about 5,000 mg per kg of the supplemented animal feed, vitamin B9 (folic acid) in an amount from about 0.5 to about 5.0 mg per kg of the supplemented animal feed, vitamin B10 (para amino benzoic acid) in an amount from about 50 mg per kg to about 1,000 mg per kg of the supplemented animal feed, vitamin B12 (cyano cobalamin) in an amount from about 0.003 to about 0.05 mg per kg of the supplemented animal feed, vitamin K3 in an amount from about 0.5 to about 5.0 mg per kg of the supplemented animal feed, beta-carotene in an amount from about 500 to about 20,000 mg per kg of the supplemented animal feed, and vitamin C in an amount from about 20 to about 200 mg per kg of the supplemented animal feed.

As another example, the supplemented animal feed may comprise any one or more of vitamin A in an amount from about 2,000 to about 4,000 IU per kg of the supplemented animal feed, vitamin D3 in an amount from about 1,000 to about 2,000 IU per kg of the supplemented animal feed, vitamin E in an amount from about 15 to about 25 IU per kg of the supplemented animal feed, vitamin B1 (thiamin) in an amount from about 0.5 to about 1.0 mg per kg of the supplemented animal feed, vitamin B2 (riboflavin) in an amount from about 1.0 to about 2.5 mg per kg of the supplemented animal feed, vitamin B3 (niacin) in an amount from about 15 to about 25 mg per kg of the supplemented animal feed, choline in an amount from about 200 to about 800 mg per kg of the supplemented animal feed, vitamin B5 (pantothenic acid) in an amount from about 5.0 to about 10.0 mg per kg of the supplemented animal feed, vitamin B6 (pyroxidone) in an amount from about 0.5 to about 2.0 mg per kg of the supplemented animal feed, biotin in an amount from about 0.05 to about 0.10 mg per kg of the supplemented animal feed, inositol in an amount from about 500 mg per kg to about 1000 mg per kg of the supplemented animal feed, vitamin B9 (folic acid) in an amount from about 0.50 to about 1.0 mg per kg of the supplemented animal feed, vitamin B10 (para amino benzoic acid) in an amount from about 50 mg per kg to about 200 mg per kg of the supplemented animal feed, vitamin B12. (cyano cobalamin) in an amount from about 0.003 to about 0.007 mg per kg of the supplemented animal feed, vitamin K3 in an amount from about 0.5 to about 1.5 mg per kg of the supplemented animal feed, beta-carotene in an amount from about 500 to about 4,000 mg per kg of the supplemented animal feed, and vitamin C in an amount from about 20 to about 100 per kg of the supplemented animal feed.

The supplemented animal feed may comprise one or more encapsulated minerals. For example, the supplemented animal feed may comprise any one or more of cobalt in an amount from about 0.20 to 5 mg per kg of the supplemented animal feed, copper in an amount from about 2.0 to 20 mg per kg of the supplemented animal feed, selenium in an amount from about 0.05 to 0.30 mg per kg of the supplemented animal feed, iodine in an amount from about 0.25 to 5.0 mg per kg of the supplemented animal feed, iron in an amount from about 10 to 100 mg per kg of the supplemented animal feed, manganese in an amount from about 15 to 150 mg per kg of the supplemented animal feed, zinc in an amount from about 15 to 1500 mg per kg of the supplemented animal feed, calcium in an amount from about 5,000 to 20,000 mg per kg of the supplemented animal feed, sodium in an amount from about 500 to 2,500 mg per kg of the supplemented animal feed, potassium in an amount from about 2,000 to 10,000 mg per kg of the supplemented animal feed, phosphorus in an amount from about 1000 to 10,000 mg per kg of the supplemented animal feed, and magnesium in an amount from about 100 to about 500 mg per kg of the supplemented animal feed.

As another example, the supplemented animal feed may comprise any one or more of cobalt in an amount from about 0.20 to 1.0 mg per kg of the supplemented animal feed, copper in an amount from about 2.0 to 5.0 mg per kg of the supplemented animal feed, selenium in an amount from about 0.05 to 0.2 mg per kg of the supplemented animal feed, iodine in an amount from about 0.25 to 0.5 mg per kg of the supplemented animal feed, iron in an amount from about 10 to 40 mg per kg of the supplemented animal feed, manganese in an amount from about 15 to 50 mg per kg of the supplemented animal feed, zinc in an amount from about 15 to 50 mg per kg of the supplemented animal feed, calcium in an amount from about 5,000 to 10,000 mg per kg of the supplemented animal feed, sodium in an amount from about 500 to 1,000 mg per kg of the supplemented animal feed, potassium in an amount from about 2,000 to 5,000 mg per kg of the supplemented animal feed, phosphorus in an amount from about 1000 to 4,000 mg per kg of the supplemented animal feed, and magnesium in an amount from about 100 to about 200 mg per kg of the supplemented animal feed.

The supplemented animal feed may comprise one or more encapsulated amino acids. For example, the supplemented animal feed may comprise any one or more of alanine in an amount from about 2 to about 10 g per kg of the supplemented animal feed, arginine in an amount from about 2 to about 10 g per kg, asparagine in an amount from about 3 to about 15 g per kg, aspartic acid in an amount from about 3 to about 15 g per kg, cysteine in an amount from about 0.5 to about 2.5 g per kg, glutamine in an amount from about 4 to about 2.0 g per kg, glutamic acid in an amount from about 3 to about 15 g per kg, glycine in an amount from about 2.5 to about 12 g per kg, histidine in an amount from about 0.5 to about 12 g per kg, isoleucine in an amount from about 0.6 to about 3 g per kg, lysine in an amount from about 2 to about 10 g per kg, methionine in an amount from about 1 to about 6 g per kg, phenylalanine in an amount from about 1 to about 5 g per kg, proline in an amount from about 2.5 to about 12 g per kg, serine in an amount from about 1 to about 5 g per kg, threonine in an amount from about 1 to about 5 g per kg, tryptophan in an amount from about 0.5 to about 3.5 g per kg, tyrosine in an amount from about 1 to about 5 g per kg, and valine in an amount from about 0.6 to about 3 mg per kg.

As another example, the supplemented animal feed may comprise any one or more of alanine in an amount from about 2 to about 7 g per kg of the supplemented animal feed, arginine in an amount from about 2 to about 7 g per kg, asparagine in an amount from about 3 to about 10 g per kg, aspartic acid in an amount from about 3 to about 10 g per kg, cysteine in an amount from about 0.5 to about 2 g per kg, glutamine in an amount from about 4 to about 14 g per kg, glutamic acid in an amount from about 3 to about 10 g per kg, glycine in an amount from about 2.5 to about 8 g per kg, histidine in an amount from about 0.5 to about 1.5 g per kg, isoleucine in an amount from about 0.5 to about 2 g per kg, lysine in an amount from about 2 to about 7 g per kg, methionine in an amount from about 1.2 to about 4.2 g per kg, phenylalanine in an amount from about 1 to about 3.5 g per kg, proline in an amount from about 2.5 to about 8.5 g per kg, serine in an amount from about 1 to about 3.5 g per kg, threonine in an amount from about 1 to about 3.5 g per kg, tryptophan in an amount from about 0.5 to about 2.5 g per kg, tyrosine in an amount from about 1 to about 3.5 g per kg, and valine in an amount from about 0.5 to about 2 g per kg.

The supplemented animal feed may further comprise one or more antibiotics, antibiotic growth promoters, anticoccidial additives, prebiotics, probiotics, hormones, or in-feed enzymes as typically used in commercial animal feed diets.

The compounds and processes of the invention will be better understood by reference to the following examples, which are intended as an illustration of and not a limitation upon the scope of the invention.

### 4. EXAMPLES

The following Examples are offered as illustrative as a partial scope and particular embodiments of the disclosure and are not meant to be limiting of the scope of the disclosure.

### Example 1

This study was designed to evaluate the effect of dietary inclusion level of microencapsulation protected premix containing vitamins, trace minerals, and amino acids on broiler growth performance. Specifically, the study tested whether inclusion level of encapsulated premix nutrients can be reduced without adverse effects on growth performance on chicks.

Animals: 336 male Ross X Ross chicks were vaccinated against Market infection and infectious bronchitis at 1 day of age and placed in 55 wire-floor battery cages.

Treatments: Dietary treatments were randomly assigned to 11 replicate cages containing 5 chicks. The experimental treatments were as follows:
L100-free-form premix (not protected by encapsulation) delivered at full dose
P100-protected premix (nutrients delivered at 100% of L100)
P75 protected premix (nutrients delivered at 75% of L100)
P50 protected premix (nutrients delivered at 50% of L100)
P25 protected premix (nutrients delivered at 25% of L100)

Details of the feed analysis are highlighted in Table 1 below. D.M indicates dry matter and includes all subsequent ingredients. C.P. indicates crude protein and includes all subsequent amino acids. M+C indicates methionine+cysteine.

TABLE 1
Dietary Treatment Nutrient Analysis as performed
by Degussa and Shur-Gain Laboratories

| | | | | |
|---|---|---|---|---|
| L100 | P100 | P75 | P50 | P25 |

Starter
Degussa

| | | | | | |
|---|---|---|---|---|---|
| D.M. % | 88 | 88 | 88 | 88 | 88 |
| C.P. % | 18.70 | 16.33 | 17.02 | 19.31 | 14.16 |
| Methionine, % | 0.450 | 0.474 | 0.397 | 0.415 | 0.342 |
| M + C, % | 0.753 | 0.748 | 0.677 | 0.724 | 0.594 |
| Lysine, % | 0.964 | 0.884 | 0.843 | 0.973 | 0.675 |
| Threonine, % | 0.709 | 0.636 | 0.633 | 0.719 | 0.539 |
| Arginine, % | 1.125 | 0.946 | 0.974 | 1.153 | 0.815 |
| Iso-leucine, % | 0.739 | 0.630 | 0.648 | 0.737 | 0.557 |
| Valine, % | 0.874 | 0.751 | 0.777 | 0.873 | 1.431 |

Shur Gain

| | | | | | |
|---|---|---|---|---|---|
| D.M. % | 88 | 88 | 88 | 88 | 88 |
| C.P. % | 18.06 | 15.54 | 15.48 | 18.95 | 17.66 |
| Fat % | 5.056 | 5.086 | 4.380 | 5.000 | 4.440 |
| Na % | 0.071 | 0.050 | 0.061 | 0.091 | 0.071 |
| Ca % | 0.515 | 0.373 | 0.425 | 0.625 | 0.565 |
| P % | 0.575 | 0.484 | 0.465 | 0.595 | 0.565 |
| K % | 0.747 | 0.666 | 0.597 | 0.766 | 0.676 |
| Fiber | 4.168 | 3.461 | 3.550 | 3.820 | 3.704 |

Grower
Degussa

| | | | | | |
|---|---|---|---|---|---|
| D.M. % | 88 | 88 | 88 | 88 | 88 |
| C.P. % | 15.48 | 19.35 | 15.84 | 16.91 | 18.19 |
| Methionine, % | 0.343 | 0.443 | 0.359 | 0.350 | 0.358 |
| M + C, % | 0.598 | 0.747 | 0.630 | 0.627 | 0.657 |
| Lysine, % | 0.709 | 1.003 | 0.771 | 0.831 | 0.908 |
| Threonine, % | 0.542 | 0.693 | 0.577 | 0.612 | 0.672 |
| Arginine, % | 0.860 | 1.152 | 0.916 | 0.996 | 1.083 |
| Iso-leucine, % | 0.572 | 0.761 | 0.605 | 0.661 | 0.716 |
| Valine, % | 0.691 | 0.886 | 0.724 | 0.783 | 0.837 |

Shur-Gain

| | | | | | |
|---|---|---|---|---|---|
| D.M. % | 88 | 88 | 88 | 88 | 88 |
| C.P. % | 15.72 | 19.38 | 17.40 | 17.12 | 16.86 |
| Fat % | 6.417 | 6.173 | 6.316 | 6.257 | 5.960 |
| Na % | 0.080 | 0.120 | 0.101 | 0.110 | 0.080 |
| Ca % | 0.330 | 0.539 | 0.453 | 0.511 | 0.431 |
| P % | 0.441 | 0.479 | 0.453 | 0471 | 0.421 |
| K % | 0.727 | 0.737 | 0.698 | 0.716 | 0.666 |
| Fiber | 3.683 | 3.835 | 4.420 | 3.458 | 3.593 |

Feed program: The 5 dietary treatments were given to the birds during 2 feed phases. The starter phase was given from 0-14 days of age, and the grower phase was given from 15-30 days of age. Both feed phases were formulated to be identical except for the inclusion of the experimental treatment premixes, and they contained antibiotic growth promoters and anticoccidial feed additives as typically used in commercial broiler diets. The feed was provided to the birds for ad libitum consumption as a mash form and the premix additives were mixed on site at the Jefo/Ciraa research facility.

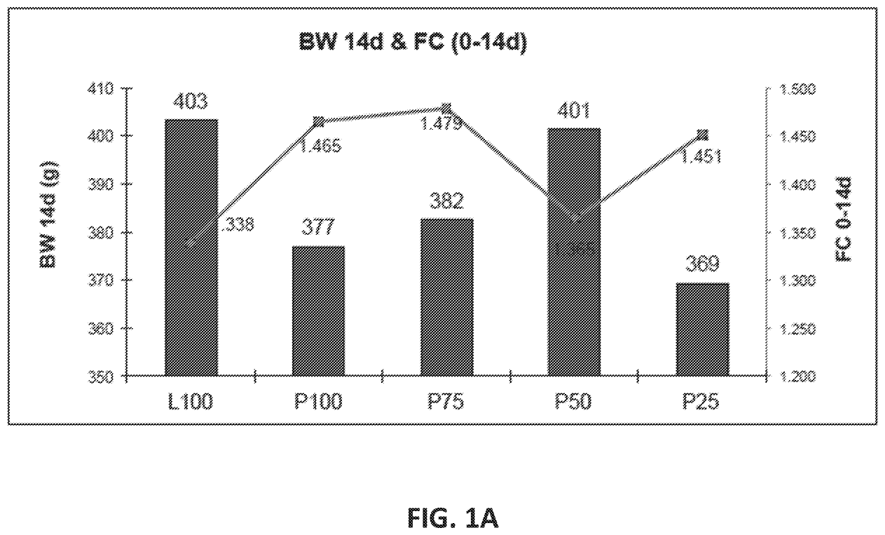

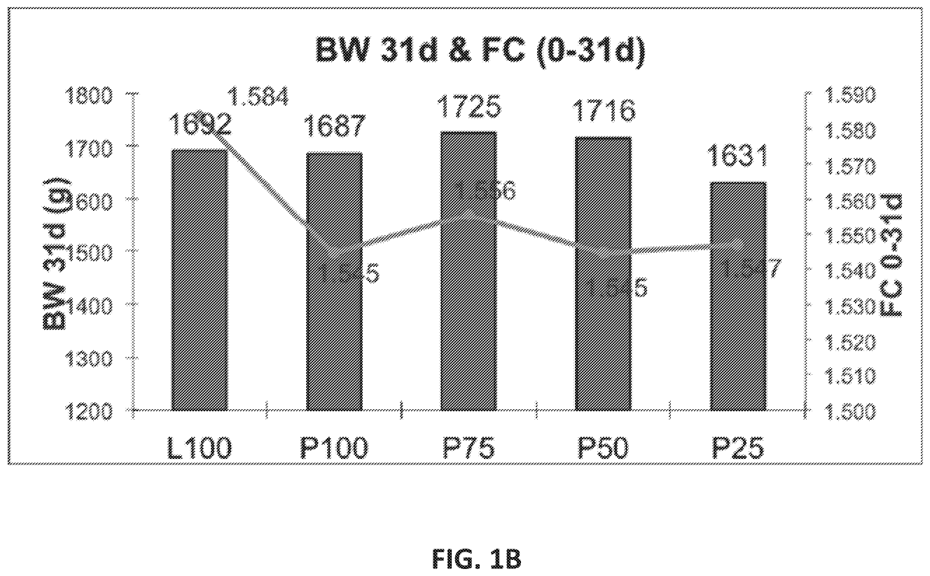

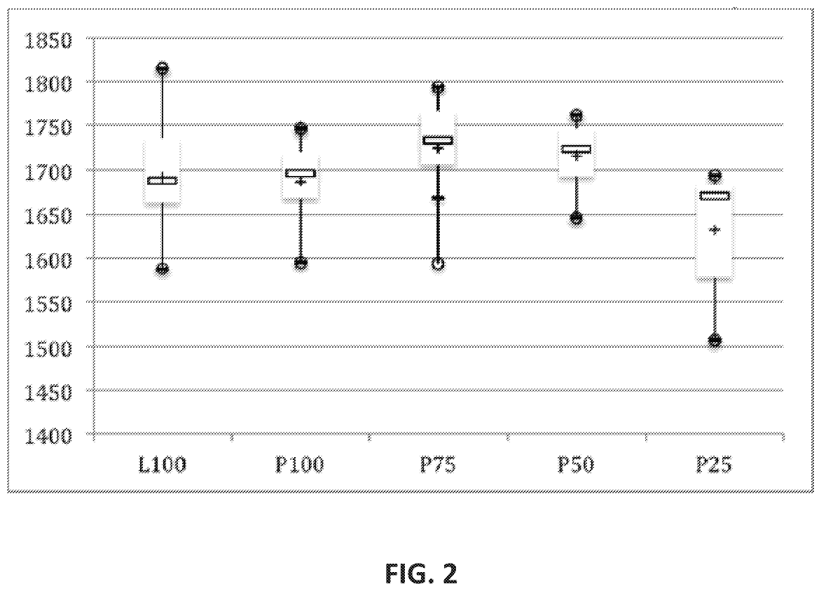

Results: The effect of dietary treatment on body weight and feed:gain ratio (FC) is shown in FIGS. 1A-B and FIG. 2. As shown in FIG. 1B and in FIG. 2, dietary treatment had no significant effect on body weight during the overall growth trial. In addition, no significant differences in feed:gain ratio were shown between treatment groups. Taken together, this data indicates that animals that were fed protected premix nutrients, even those fed protected premix nutrients at lower dietary dosages, did not show significant differences in growth performance compared to control animals that were fed unprotected premix at the full dietary dosage.

### Example 2

This study was conducted to determine whether micro-encapsulated premix will improve the effectiveness of the most sensitive nutritional ingredients (amino-acids, vitamins, enzymes and lime) and thus reduce their rate of dietary inclusion level.

Animals: 270 male Ross X Ross chicks were vaccinated against Market infection and infectious bronchitis at 1 day of age and placed in 54 wire-floor battery cages.

Treatments: Dietary treatments were randomly assigned to 9 replica cages containing 5 chicks. The feed was manufactured by Benjamin's feed mill. All the feed was formulated as a corn-soymeal basal diet in mash form. To these basal diets, the different premixes were mixed (10 min rotations per batch of 50 kg) to prepare the dietary treatments. The feeding program was divided into three phases: starter 0-14 days, grower 14-28 days, and finisher 28-35 days of age. The experimental treatments were as follows:
TEM1-premix WAD (vitamins, amino acids, and minerals) delivered at 100% of free normal dose
TEM2-premix MVAO delivered at 50% of free normal dose
TEM 3-premix MVAO delivered at 25% of free normal dose
MIC1—protected premix MVAO delivered at 100% equivalent to free normal dose
MIC2—protected premix MVAO delivered at 50% equivalent to free normal dose
MIC3—protected premix MVAO delivered at 25% equivalent to free normal dose

Data Collection: Group body weights (including the weights of dead birds) and cumulative feed consumption was determined at the end of each week and feed conversion ratio (FCR) was calculated. Statistical analysis of the variance (ANOVA) with multiple-range comparisons tests (FISHER LSD) was performed using software XLSTAT (Addinsoft, version 2015.2.01) to detect significant treatment effects.

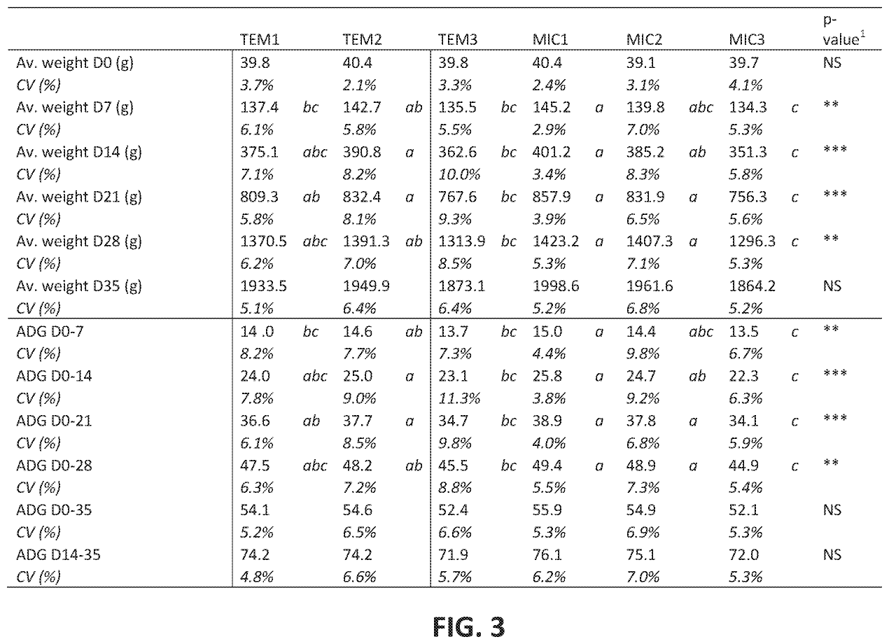

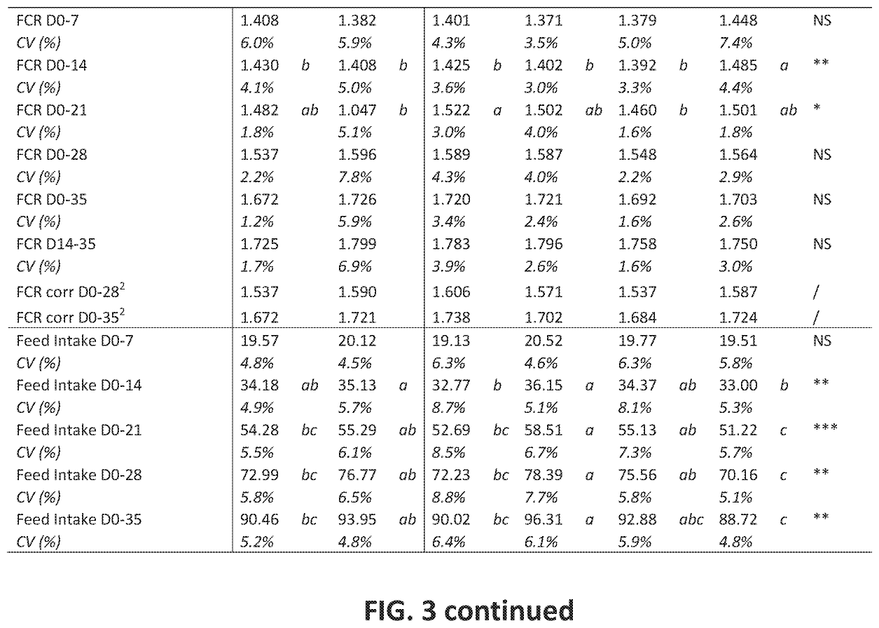

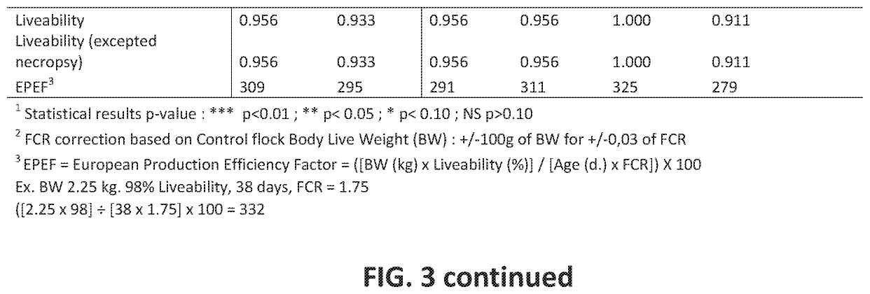

Results: Results for the above study are shown in FIGS. 3-6. The finishing period (from 28 to 35 days of age) showed reduced performances for all treatments. The most plausible explanation is a lack of space for 5 animals in the cages. It is thus preferable to concentrate on the performances until 28 days instead of 35 days of age.

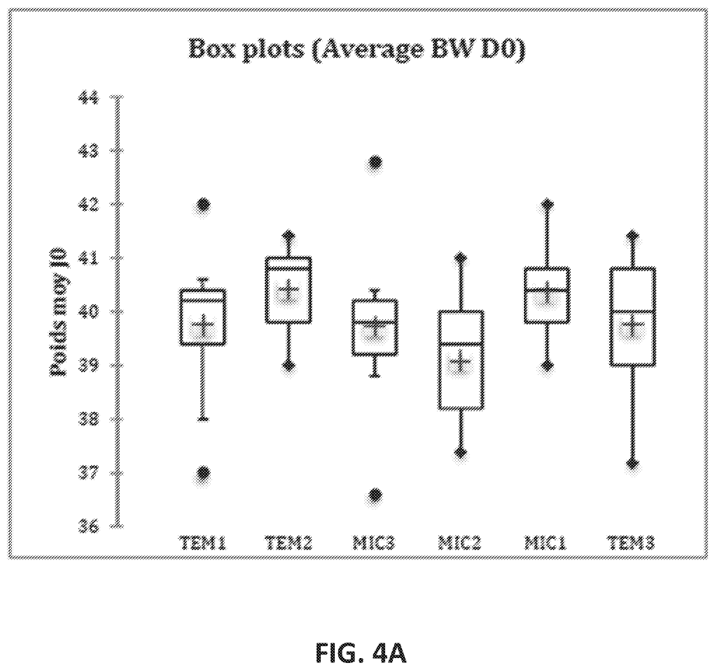

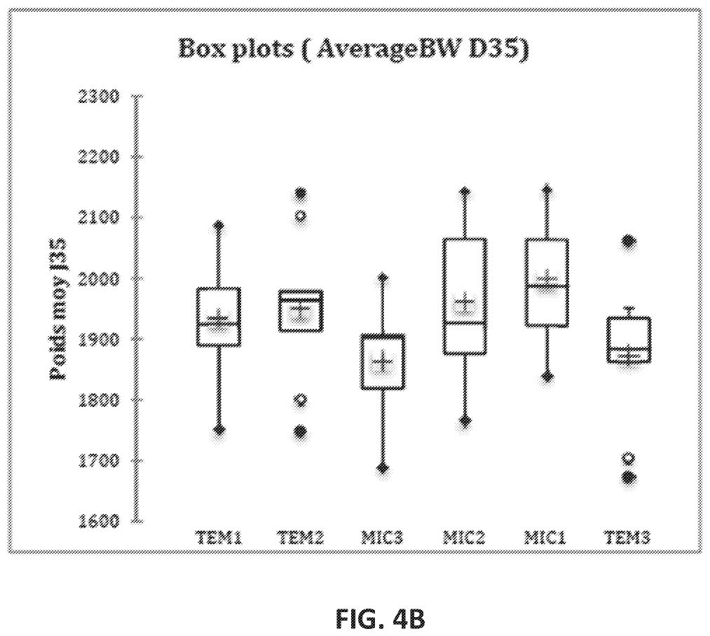

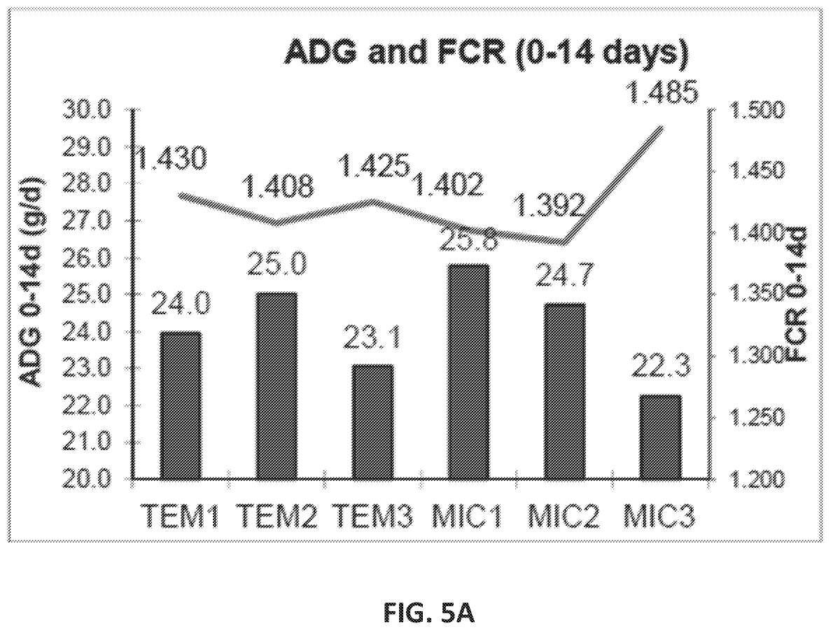

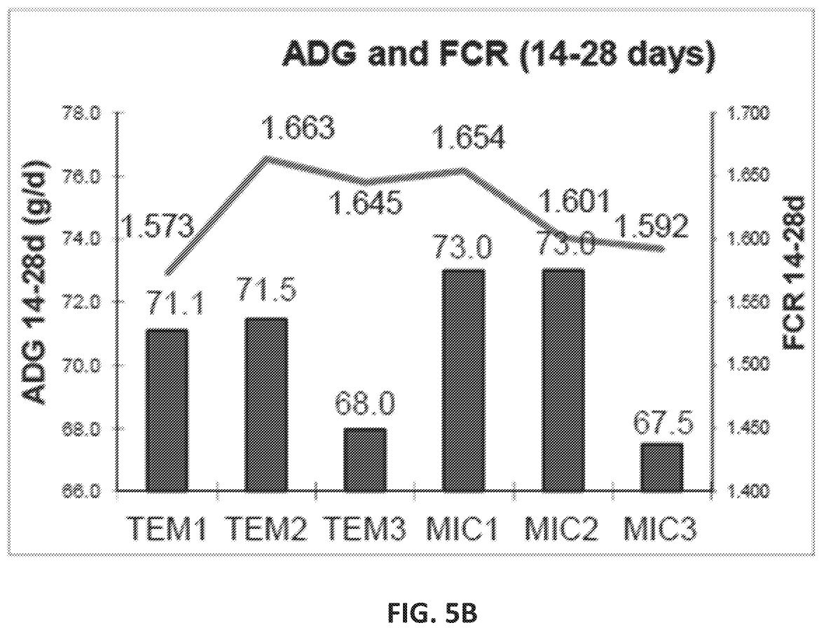

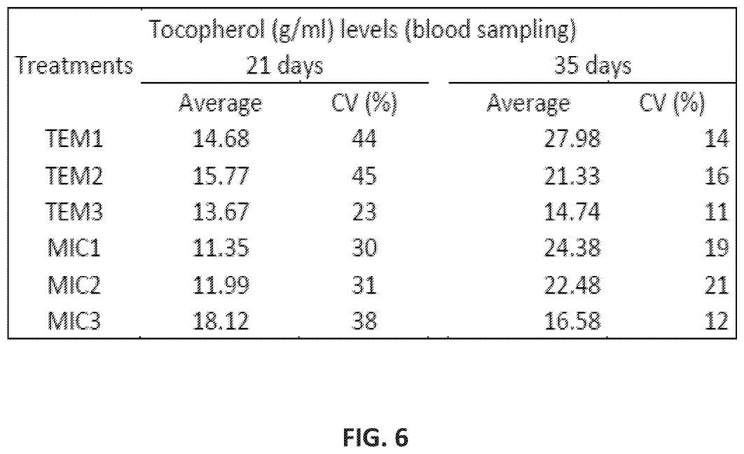

As shown in FIG. 3, the best (lowest) FCR was obtained for the treatment group MIC2 (50% of reduction of the normal dose with protected vitamins) and for TEM 1 (100% of free vitamins). The FCR for days 0-28 for the TEM1 group was 1.53, whereas the FCR for the MIC2 group was 1.548. As shown in FIG. 4A-B, no significant differences in body weight at day 0 (FIG. 4A) or day 35 (FIG. 4B) were seen between MIC2 and TEM1 treatment groups. As shown in FIG. 5B, no significant differences in average daily growth or FCR were seen between TEM1 and MIC2 treatment groups from 14-28 days of age. Furthermore, no significant treatment effects were observed on serum vitamin E concentrations (FIG. 6). In conclusion, the 50% microencapsulated premix treatment group (MIC2) demonstrated similar results to the full dose free premix treatment group (TEM1), indicating that microencapsulation allows for lower dietary, inclusion levels than typically used for conventional premixes.

### Example 3

This study was conducted to evaluate the advantages of micro-encapsulation on premix components and their zootechnical impact on broilers.

Animals: Day hatch broilers (ROSS 308) were equally distributed in cages (6 broilers per cage) in order to compare 5 treatments on zootechnical performances with 5 repetitions each.

Treatments: Feeds were distributed as mash feed in two sequences, starter from 0-14 days of age and grower from 14-28 days of age. The trial was run on a 28 day period. Treatments were as follows:
T1 F100VOA Free premix/(100% free vitamins, minerals, and amino acids)
T2 F100VOA Free premix/free (supplying 40% of F100VOA)
T3 F100VA_P40A Combo (100% free vitamins and minerals and 40% amino acids but protected)
T4 F100VA_P40O Combo (100% free vitamins and amino acids and 40% minerals but protected)
T5 F100AO_P40V Combo (100% free amino acids and minerals and 40% vitamins but protected)

Feed analysis for each of the above treatment groups are shown in Table 2 and Table 3 below.

TABLE 2
Feed Analysis By Treatment Group

| | | | | |
|---|---|---|---|---|
| F100VOA | F40VOA | F100VO_P40A | F100VA_P40O | F100AO_P40V |

Starter

| | | | | | |
|---|---|---|---|---|---|
| D.M. % | 88 | 88 | 88 | 88 | 88 |
| C.P. % | 22.91 | 22.22 | 22.74 | 22.47 | 22.20 |
| Fat % | 3.96 | 3.93 | 4.33 | 4.07 | 4.14 |
| Fibre Det. Acid | 3.84 | 3.82 | 3.54 | 3.63 | 3.92 |

Grower

| | | | | | |
|---|---|---|---|---|---|
| D.M. % | 88 | 88 | 88 | 88 | 88 |
| C.P. % | 20.70 | 20.02 | 20.71 | 20.27 | 20.42 |
| Fat % | 4.81 | 4.81 | 5.01 | 4.93 | 5.03 |
| Fibre Det. Acid | 3.59 | 3.83 | 3.64 | 3.50 | 3.75 |

TABLE 3
Analysis of Vitamins and Minerals by Treatment Group¹

| | F100VOA | F40VOA | F100VO_P40A | F100VA_P40O | F100AO_P40V |
|---|---|---|---|---|---|
| Vit A (IU) | 12,600,000.00 | 5,040,000.00 | 12,600,000.00 | 12,600,000.00 | levels of F40VOA |
| Vit D (IU) | 3,000,000.00 | 1,200,000.00 | 3,000,000.00 | 3,000,000.00 | levels of F40VOA |
| Vit E, mg | 49,999.50 | 19,999.80 | 49,999.50 | 49,999.50 | levels of F40VOA |
| Vit K3, mg | 2,550.00 | 1,020.00 | 2,580.00 | 2,550.00 | levels of F40VOA |
| Vit B8, Biotin, mg | 201.00 | 80.40 | 201.00 | 201.00 | levels of F40VOA |
| Vit B9, Folic Acid, mg | 1,005.00 | 402.00 | 1,005.00 | 1,005.00 | levels of F40VOA |
| Vit B3, Niacin, mg | 49,950.00 | 19,980.00 | 49,950.00 | 49,950.00 | levels of F40VOA |
| Vit B5, Pantothenic acid, mg | 14,100.00 | 5,640.00 | 14,100.00 | 14,100.00 | levels of F40VOA |
| Vit B2, Riboflavin, mg | 6,000.00 | 2,400.00 | 6,000.00 | 6,000.00 | levels of F40VOA |
| Vit B12, Cobalamin, mg | 15.00 | 6.00 | 15.00 | 15.00 | levels of F40VOA |
| Vit B6, Pyridorin, mg | 3,600.00 | 1,440.00 | 3,600.00 | 3,600.00 | levels of F40VOA |
| Vit B1, Thiamin, mg | 3,600.00 | 1,440.00 | 3,600.00 | 3,600.00 | levels of F40VOA |
| Iodine, mg | 1,005.00 | 402.00 | 3,005.00 | levels of F40VOA | 1,005.00 |
| Iron, mg | 90,000.00 | 36,000.00 | 90,000.00 | levels of F40VOA | 90,000.00 |
| Selenium, mg | 300.00 | 120.00 | 300.00 | levels of F40VOA | 300.00 |
| Manganese, mg | 85,500.00 | 34,200.00 | 85,500.00 | levels of F40VOA | 85,500.00 |
| Copper, mg | 10,050.00 | 4,020.00 | 10,050.00 | levels of F40VOA | 10,050.00 |
| Zinc, mg | 85,500.00 | 34,200.00 | 85,500.00 | levels of F40VOA | 85,500.0.00 |
| Protected-I, g | | | | 3.33 | |
| Protected-Fe, g | | | | 360.00 | |
| Protected-Sn, g | | | | 12.00 | |
| Protected-Mn, g | | | | 123.91 | |
| Protected-CuZ, g | | | | 80.40 | |
| Protected-Zn, g | | | | 28.57 | |
| Methionine, g | 2,600.00 | 1,040.00 | levels of F40VOA | 2,600.00 | 2,600.00 |
| Lysine, g | 3,000.00 | 1,200.00 | levels of F40VOA | 3,000.00 | 3,000.00 |
| Threonine, g | 500.00 | 200.00 | levels of F40VOA | 500.00 | 500.00 |
| Protected Methionine, g | | | 1,872.00 | | |
| Protected Lysine, g | | | 2,736.00 | | |
| Protected Threonine, g | | | 440.00 | | |
| Protected pack of Vitamines, g | | | | | 600.00 |

¹All values are expressed as amounts per 1000 kg of complete feed fed to the animnals.

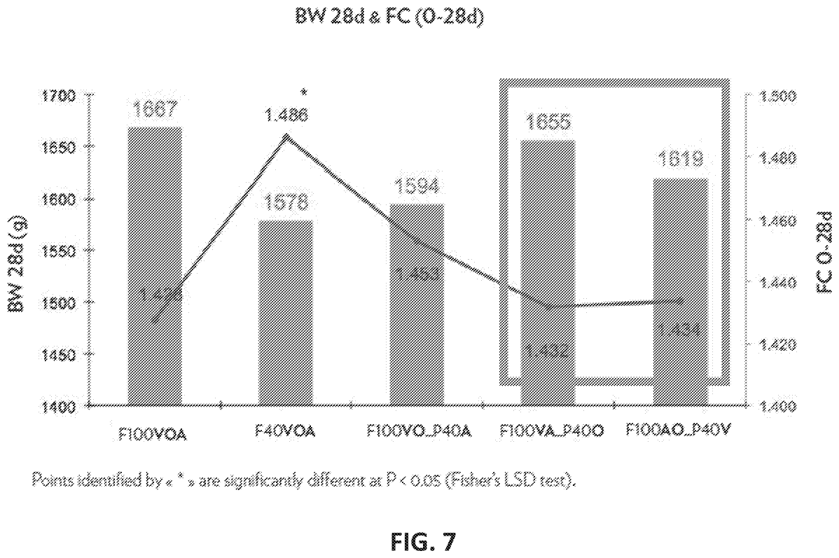

Results: Results are shown in FIG. 7. Protection of minerals or vitamins resulted in similar FCR to that seen in the F100VOA control group. This data indicates that levels of vitamins and minerals provided to animals may be reduced by up to 60% without adverse effects on growth performance.

### Example 4

Study Objective: This study was designed to determine the effect of dietary supplementation of protected vitamin and/or mineral premixes encapsulated by blend of hydrogenated vegetable oil on the growth performance, enteric mucosal morphology, hind-gut microbiome, meat yield, breast meat moisture retention and textural quality, skin pigmentation and foot health of broiler chickens. This experimental treatment response was compared to conventional free vitamin and mineral premix formulations at commercially recommended dietary specification levels (100% of daily recommendations) and at 40% and 30% of these recommended levels.

General Hypothesis Tested: This study tested the hypothesis that encapsulation of nutritional and/or nutraceutical compounds, such as vitamins and trace minerals, for controlled release will enhance their bioavailability and permit lower dietary inclusion levels by limiting chemical or microbial exposure, and thereby improve growth performance, animal welfare, enteric health and ecosystem symbiosis, and value of poultry products.

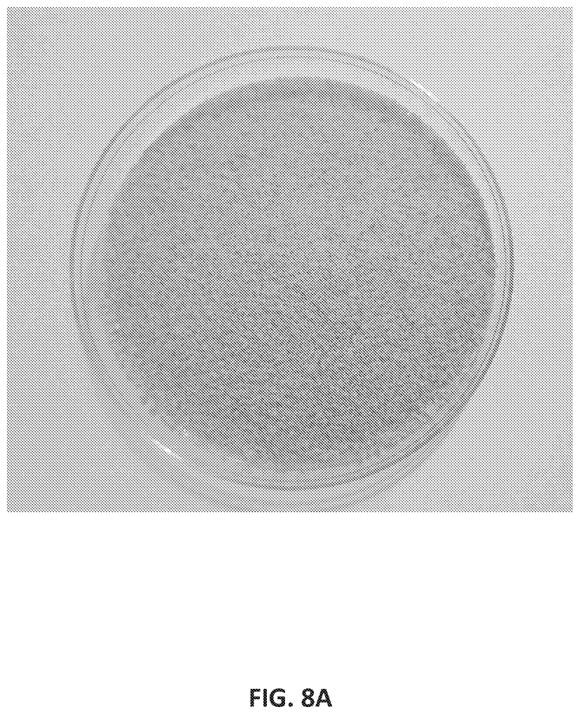

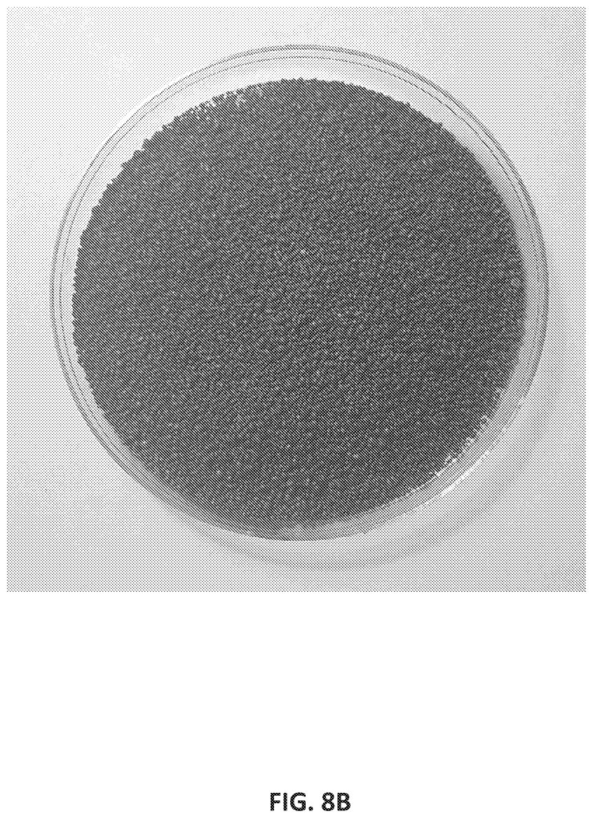

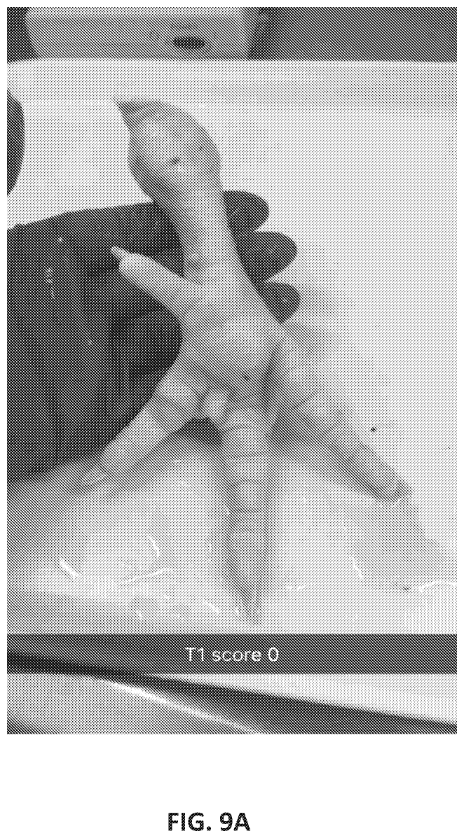

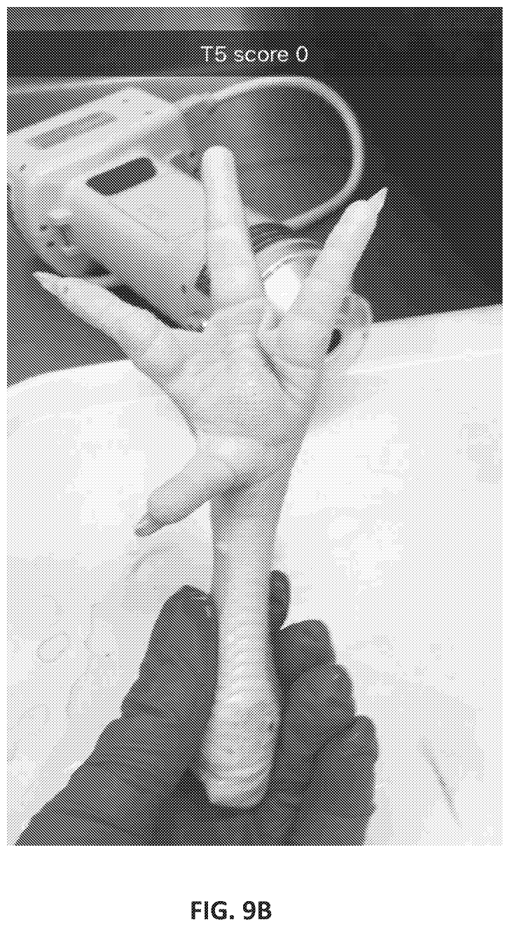

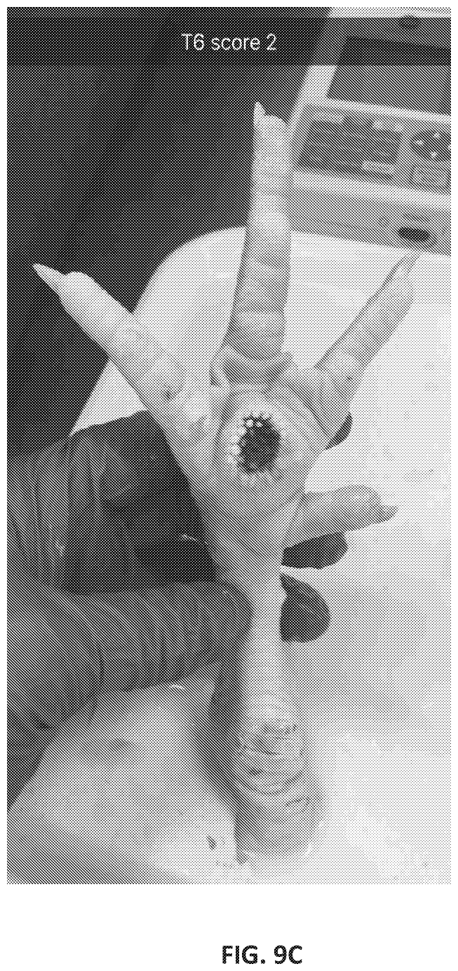

Methods: Two Experimental vitamin and mineral premixes were formulated to meet the Ross 708 recommendations for all nutrients, including vitamins and trace minerals, if added at 0.2% of the complete feed. These premixes represent the 100% treatment level either as the free form or the protected form of vitamins and mineral premixes that is encapsulated in hydrogenated vegetable oil. These vitamin and mineral premixes are illustrated in FIG. 8A and FIG. 8B, respectively.

The experiment was designed as a randomized block design. Six dietary treatments were distributed among 12 floor pens (2 pens/treatment) containing about 30 Ross 708 male boiler chickens, as shown in Table 4 below. All birds were fed a three-phase diet: starter from 1-14 days, grower from 14-28 days, and finisher from 28-42 days of age. Descriptions of the vitamin and mineral supplementation levels of the respective free and protected for each experimental treatment are shown in Table 5. Individual body weights from each pen were determined at 7, 14, 21, 28 and 42 days of age. Feed intake was determined at the same ages as body weight determination. Mortality rate was observed daily, and recorded by week, as it occurred, and the weight of mortality was recorded to adjust pen feed conversion data. Histology of the jejunum mucosa was collected and analyzed for changes in villi and crypt height and depth on day 28. Microbiome from the ceca of the data was sent the UNC Microbiome Center for analysis to determine changes in the population that could alter gut health and broiler performance.

All data were statistically analyzed using SMP Pro 13 via the GLM Procedure. Significant differences between treatment groups were determined via Tukey HSD (p≤0.05) and differences from the control (treatment 1) were determined using Dunnett's test. To determine the main effects and interaction effects of vitamin and mineral premix form (free versus protected) and premix supplementation level (100% versus 40%), factorial analysis was performed using only treatments 1, 2, 5 and 6.

TABLE 4
Dietary Treatment Regimen

| | Vitamin Premix | | Mineral Premix | |
|---|---|---|---|---|
| | supplementation | | Supplementation | |
| | Level of | | Level of | |
| | supple- | | supple- | |
| Treatments | mentation | | mentation | |
| ID | (%) | Form | (%) | Form |
| 1 | 100 | Free | 100 | Free |
| 2 | 100 | Protected | 100 | Protected |
| 3 | 100 | Free | 40 | Protected |
| 4 | 40 | Protected | 100 | Free |
| 5 | 40 | Protected | 40 | Protected |
| 6 | 40 | Free | 40 | Free |

TABLE 5
Dietary levels of vitamins and trace minerals supplemented as free or protected premixes

| | Experimental Treatments Used in Trial 1 | | | | | | | | | | | |
|---|---|---|---|---|---|---|---|---|---|---|---|---|
| Ingredients | 1 | | 2 | | 3 | | 4 | | 5 | | 6 | |
| Vitamin Premix | Biologically activity of Nutrient Expressed as the Unit per kg of Complete Diet | | | | | | | | | | | |
| Vitamin A Suppl. | 10,000 | IU | 10,000 | IU | 10,000 | IU | 4,000 | IU | 4,000 | IU | 4,000 | IU |
| 1,000,000 IU/g | | | | | | | | | | | | |
| Vitamin D3 Suppl. 500,000 ICU/g | 4,500 | ICU | 4,500 | ICU | 4,500 | ICU | 1,800 | ICU | 1,800 | ICU | 1,800 | ICU |
| Vitamin E Suppl. 500 IU/g | 65 | IU | 65 | IU | 65 | IU | 26 | IU | 26 | IU | 26 | IU |
| Vitamin K3 MNB 43% | 3 | mg | 3 | mg | 3 | mg | 1.2 | mg | 1.2 | mg | 1.2 | mg |
| Thiamin Mononitrate | 2.5 | mg | 2.5 | mg | 2.5 | mg | 1.0 | mg | 1.0 | mg | 1.0 | mg |
| 76.92% | | | | | | | | | | | | |
| Riboflavin HCL 80% | 6.5 | mg | 6.5 | mg | 6.5 | mg | 2.6 | mg | 2.6 | mg | 2.6 | mg |
| Pyridoxine HCL 81.48% | 3.2 | mg | 3.2 | mg | 3.2 | mg | 1.28 | mg | 1.28 | mg | 1.28 | mg |
| d-Ca Pantothenate 91% | 18 | mg | 18 | mg | 18 | mg | 7.2 | mg | 7.2 | mg | 7.2 | mg |
| Folic acid 99% | 1.9 | mg | 1.9 | mg | 1.9 | mg | 0.95 | mg | 0.95 | mg | 0.95 | mg |
| Biotin 2% | 0.18 | mg | 0.18 | mg | 0.18 | mg | 0.072 | mg | 0.072 | mg | 0.072 | mg |
| Niacin 99% | 60 | mg | 60 | mg | 60 | mg | 24 | mg | 24 | mg | 24 | mg |
| Vitamin B12 1% | 0.017 | mg | 0.017 | mg | 0.017 | mg | 0.0068 | mg | 0.0068 | mg | 0.0068 | mg |
| Hydrogenated Fat Encaps. | 0 | g | 0.335 | g | 0 | g | .134 | g | .134 | g | 0 | g |
| Trace Mineral Premix | Biologically activity of Nutrient Expressed as the Unit per kg of Complete Diet | | | | | | | | | | | |
| EDDI, 79% I | .95 | mg | .95 | mg | 0.38 | mg | .95 | mg | 0.38 | mg | 0.38 | mg |
| Ferrous Sulfate, 30% Fe | 50 | mg | 50 | mg | 20 | mg | 50 | mg | 20 | mg | 20 | mg |
| Sodium Selenite, 45% Se | 0.3 | mg | 0.3 | mg | 0.12 | mg | 0.3 | mg | 0.12 | mg | 0.12 | mg |
| Zinc Oxide, 72% Zn | 85 | mg | 85 | mg | 34 | mg | 85 | mg | 34 | mg | 34 | mg |
| Manganese Oxide, 60% Mn | 85 | mg | 85 | mg | 34 | mg | 85 | mg | 34 | mg | 34 | mg |
| Copper Sulfate, 25% Cu | 10 | mg | 10 | mg | 4 | mg | 10 | mg | 4 | mg | 4 | mg |
| Hydrogenated Fat Encaps. | 0 | g | 0.532 | g | 0.213 | g | 0 | g | 0.213 | g | 0 | g |

| Other Ingredients | Grams per Kg of Complete Diet | | | | | |
|---|---|---|---|---|---|---|
| Hydrogenated Veg. Fat¹ | 0.867 | 0 | 0.335 | .213 | 0 | .347 |
| Vermiculite carrier | 0.400 | 0.400 | 0.320 | 0.320 | 0.160 | 0.160 |

¹Hydrogenated Vegetable oil was added on the vermiculite carrier in the free vitamin or mineral premixes to equate the amount of hydrogenated vegetable fat used to encapsulate the vitamins and minerals in the protected premixes.

Results: Growth performance was evaluated at 7, 14, 21, 28 or 42 days of age. No significant treatment effects were observed on feed intake (Table 6) or adjusted feed conversion ratio (Table 8) during any time period. However, a significant premix level effect was observed on day 28 body weight (Table 7), indicating that the lower vitamin and mineral premix supplementation increased day 28 body weight regardless of form. It is noteworthy that Ross 708 Male broilers are typically recovering from enteric disease challenges prior to 28 days of age. Early enteric disease challenge increases variation in growth performance. Impressively, a significant premix form X supplementation level was observed on the body weight % coefficient of variation at 21 days (Table 9). Encapsulation protection has no effect on 21-day body weight variation when supplemented at 100% of breeder recommendations, but weight variation decreased significantly at the 40% of breeder recommendations. Evidently, protecting vitamin and mineral premixes by encapsulation in hydrogenated fat reduces the adverse effects of enteric challenge on the variation of growth, and preventing over supply of these nutrients by lower supplementation levels favors better body weight gain during the early growth,

TABLE 6
Effect of dietary level and form of vitamin
and mineral premix supplementation on feed
intake (kg) of Male Ross 708 boiler chickens

| Treatment | 0-7 d | 0-14 d | 0-21 d | 0-28 d | 0-42 d |
|---|---|---|---|---|---|
| 1) 100% Free V + M | 0.176 | 0.408 | 0.941 | 1.980 | 4.206 |
| 2) 100% Prot V + M | 0.181 | 0.426 | 0.964 | 1.983 | 4.222 |
| 3) 100% Free V + | 0.179 | 0.422 | 0.968 | 1.805 | 3.939 |
| 40% Prot. M | | | | | |
| 4) 40% Prot V + | 0.82 | 0.431 | 0.961 | 1.980 | 4.279 |
| 100% Free M | | | | | |
| 5) 40% Prot V + M | 0.185 | 0.436 | 0.991 | 2.070 | 4.248 |
| 5) 40% Free V + M | 0.174 | 0.412 | 0.964 | 1.991 | 4.233 |
| P value | 0.2726 | 0.4195 | 0.8051 | 0.3222 | 0.4652 |
| Source of Variation¹ | (P-value) | | | | |
| Premix Form | 0.11 | 0.12 | 0.078 | 0.22 | 0.90 |
| (Free vs Protected) | | | | | |
| Premix Level | 0.66 | 0.56 | 0.078 | 0.15 | 0.83 |
| (100% vs 40%) | | | | | |
| Level X Form | 0.43 | 0.80 | 1.00 | 0.24 | 1.00 |
| SEM | 0.002 | 0.005 | 0.005 | 0.014 | 0.058 |

¹Source of Variation is described for the factorial analysis of 2 premix forms (Free and Protected) X 2 Premix levels (100 and 40%), from data presented by treatments 1, 2, 5, and 6.

TABLE 7
Effect of dietary level and form of vitamin
and mineral premix supplementation on body
weight (kg) of Male Ross 708 boiler chickens

| Treatment | 7 days | 14 days | 21 days | 28 days | 42 days |
|---|---|---|---|---|---|
| 1) 100% Free V + M | 0.126 | 0.343 | 0.721 | 1.229 | 2.698 |
| 2) 100% Prot V + M | 0.133 | 0.344 | 0.689 | 1.287 | 2.733 |
| 3) 100% Free V + | 0.133 | 0.354 | 0.698 | 1.166 | 2.618 |
| 40% Prot. M | | | | | |
| 4) 40% Prot V + | 0.126 | 0.339 | 0.736 | 1.246 | 2.747 |
| 100% Free M | | | | | |
| 5) 40% Prot V + M | 0.130 | 0.338 | 0.752 | 1.293 | 2.632 |
| 6) 40% Free V + M | 0.132 | 0.346 | 0.726 | 1.314 | 2.787 |
| P value | 0.1264 | 0.8550 | 0.7240 | 0.4383 | 0.9192 |
| Source of Variation¹ | (P-value) | | | | |
| Premix Form | 0.41 | 0.75 | 0.75 | 0.85 | 0.67 |
| (Free vs Protected) | | | | | |
| Premix Level | 0.59 | 0.9 | 0.9 | 0.031 | 0.96 |
| (100% vs 40%) | | | | | |
| Level X Form | 0.19 | 0.72 | 0.72 | 0.25 | 0.51 |
| SEM | 0.0015 | 0.006 | 0.006 | 0.009 | 0.07 |

¹Source of Variation is described for the factorial analysis of 2 premix forms (Free and Protected) X 2 premix levels (100 and 40%), from data presented by treatments 1, 2, 5, and 6.

TABLE 8
Effect of dietary level and form of vitamin and mineral premix
supplementation on Feed Conversion Ratio (Feed/Gain, adjusted
for mortality) of Male Ross 708 boiler chickens

| Treatment | 0-7 d | 0-14 d | 0-21 d | 0-28 d | 0-42 d |
|---|---|---|---|---|---|
| 1) 100% Free V + M | 1.41 | 1.25 | 1.33 | 1.22 | 1.47 |
| 2) 100% Prot V + M | 1.36 | 1.30 | 1.41 | 1.18 | 1.50 |
| 3) 100% Free V + | 1.35 | 1.26 | 1.42 | 1.15 | 1.38 |
| 40% Prot. M | | | | | |
| 4) 40% Prot V + | 1.49 | 1.33 | 1.33 | 1.22 | 1.46 |
| 100% Free M | | | | | |
| 5) 40% Prot V + M | 1.42 | 1.35 | 1.34 | 1.23 | 1.51 |
| 6) 40% Free V + M | 1.32 | 1.24 | 1.35 | 1.14 | 1.42 |
| P value | 0.1119 | 0.7953 | 0.2687 | 0.1384 | 0.1041 |
| Source of Variation¹ | (P-value) | | | | |
| Premix Form | 0.82 | 0.35 | 0.49 | 0.52 | 0.12 |
| (Free vs Protected) | | | | | |
| Premix Level | 0.58 | 0.77 | 0.87 | 74 | 0.51 |
| (100% vs 40%) | | | | | |
| Level X Form | 0.14 | 0.73 | 0.67 | 0.08 | 0.36 |
| SEM | 0.021 | 0.036 | 0.169 | 0.014 | 0.016 |

¹Source of Variation is described for the factorial analysis of 2 premix forms (Free and Protected) X 2 Premix levels (100 and 40%), from data presented by treatments 1, 2, 5, and 6.

TABLE 9
Effect of dietary level and form of vitamin and mineral
premix supplementation on % coefficient of variation (%
CV) of body weight (kg) of Male Ross 708 boiler chickens

| Treatment | 7 d | 14 d | 21 d | 28 d | 42 d |
|---|---|---|---|---|---|
| 1) 100% Free V + M | 17.42 | 24.22 | 21.89^{ab} | 19.21 | 14 |
| 2) 100% Prot V + M | 18.56 | 23.26 | 33.54^{a} | 22.45 | 15.59 |
| 3) 100% Free V + | 13.74 | 14.46 | 14.78^{b} | 14.81 | 11.81 |
| 40% Prot. M | | | | | |
| 4) 40% Prot V + | 15.62 | 19.31 | 17.61^{b} | 16.48 | 10.86 |
| 100% Free M | | | | | |
| 5) 40% Prot V + M | 14.74 | 16.84 | 15.21^{b} | 13.33 | 10.07 |
| 6) 40% Free V + M | 15.86 | 19.78 | 23.60^{ab} | 19.07 | 14.07 |
| P value | 0.24 | 0.3606 | 0.0177 | 0.1668 | 0.6185 |
| Source of Variation¹ | (P-value) | | | | |
| Pre mix Level | 0.09 | 0.21 | 0.051 | 0.13 | 0.42 |
| (100% vs 40%) | | | | | |
| Premix Form | 1.00 | 0.62 | 0.62 | 0.64 | 0.71 |
| (Free vs Protected) | | | | | |
| Level X Form | 0.41 | 0.80 | 0.03 | 0.14 | 0.41 |
| SEM | 0.61 | 1.82 | 1.51 | 1.22 | 1.50 |

¹Source of Variation is described for the factorial analysis of 2 premix forms (Free and Protected) X 2 Premix levels (100 and 40%), from data presented by treatments 1, 2, 5, and 6.

The Enteric Ecosystem: Gut Health and Microbiome Evaluation

The jejunum is the section of the gut where most of the nutrient absorption occurs. Jejunum mucosal histomorphometric analysis is often used to evaluate enteric health. Assessing mucosal histology at 28 days of age is particularly critical for broiler chickens because this is the age soon after they recover from coccidiosis vaccine reactions and when they begin to establish a stable enteric microflora. Jejunum villus tip width decreases as mucosal distress increases, and crypt depth increases as mucosal distress increases as a means to replenish the villi enterocytes that make up the absorptive surface area. Villus surface area is an indication of the absorptive area the animal maintains to compensate for nutrient absorption capacity. Villus surface area increases as a compensatory effort to maintain the body's need for nutrient absorption in the face of competition with the mucosal microflora. Table 10 illustrates that protecting the vitamin and trace mineral premixes by hydrogenated fat encapsulation significant reduces villi tip width, crypt depth, and villi surface area, regardless of the level of supplementation. Interestingly, treatment 3 (100% Free Vitamin premix+40% Protected trace minerals) resulted in a similar favorable response of reduced villi tip width, crypt depth and surface area, suggesting that commercially recommended levels of free minerals cause significant distress to the jejunum mucosa.

TABLE 10
Effect of dietary level and form of vitamin and mineral premix supplementation on jejunum
mucosa histomorphometric analysis of Male Ross 708 boiler chickens at 28 days of age.

| | Villi | Villi tip | Villi base | Crypt | Muscularis | High/Crypt | |
|---|---|---|---|---|---|---|---|
| | Height | width | width | depth | Thickness | Ratio | Surface |
| Treatment | (um) | (um) | (um) | (um) | (um) | (um) | (um²) |
| 1) 100% Free V + M | 1093 | 204 | 237 | 228 | 112 | 4.87 | 242,995 |
| 2) 100% Prot V + M | 928 | 190 | 223 | 182 | 129 | 5.04 | 189,840 |
| 3) 100% Free V + 40% Prot. M | 900 | 174 | 193 | 201 | 122 | 4.50 | 166,607 |
| 4) 40% Prot V + 100% Free M | 982 | 217 | 247 | 192 | 116 | 5.16 | 224,504 |
| 5) 40% Prot V + M | 979 | 153 | 186 | 189 | 121 | 5.23 | 165,271 |
| 6) 40% Free V + M | 1024 | 202 | 221 | 214 | 124 | 4.92 | 218,828 |
| P value | 0.4637 | 0.0521 | 0.0981 | 0.3060 | 0.9655 | 0.7355 | 0.0566 |
| Source of Variation | (P-value) | | | | | | |
| Premix Form (Free vs | 0.1573 | 0.0396 | 0.1386 | 0.0501 | 0.6668 | 0.4621 | 0.0213 |
| Protected) | | | | | | | |
| Premix Level (100% | 0.9071 | 0.1820 | 0.1183 | 0.8430 | 0.8875 | 0.7127 | 0.26736 |
| vs 40%) | | | | | | | |
| Level X Form | 0.4117 | 0.2299 | 0.5453 | 0.5643 | 0.5392 | 0.8426 | 0.9926 |
| SEM | 35.77 | 7.07 | 8.15 | 8.47 | 7.64 | 0.15 | 10,678 |

The gut is a dynamic ecosystem of microflora that compete with each other and with the host animal, particularly in the hindgut region (ileum and ceca/colon). Enteric microflora within the Firmicute phylum are generally symbiotic with the host animal, whereas Bacteriodetes, Tenericutes, and Proteiobacteria tend to be more competitive and typically include many of the pathogens that cause enteric disease. Table 11 illustrates the experimental treatment effects on the microbiota (Phylum) distribution on the ceca/colon of Male Ross 708 broilers at 42 days of age. As hypothesized, protection of vitamins and/or trace minerals by hydrogenated fat encapsulation will alter the gut microflora towards a population distribution that is more symbiotic with the host. The 100% protected treatment (Treatment 2) had the greatest Firmicute Phylum population, while 100% free as well as the 40% free and protected had similar percentages of the Firmicute Phylum. The ratio of Firmicutes to Bacteroidetes is consistently associated with changes in calorie intake, where a higher Firmicute population is linked to increase calorie absorption. This is ideal for broilers, in which maximum calorie utilization is necessary in their short grow-out period. It is also interesting to note the decrease in proteobacteria between the 100% free and all other treatment groups. This phylum contains multiple of the foodborne pathogens, suggesting that encapsulating and decreasing the levels of vitamins and minerals could decrease the population of foodborne pathogens.

TABLE 11
Effect of dietary level and form of vitamin and mineral premix supplementation on
ceca microbiota distribution of Male Ross 708 boiler chickens at 42 days of age.
Percentage of Phylum Recovery per Treatment (D 42)

| | | | 3) 100% | 4) 40% Prot | | |
|---|---|---|---|---|---|---|
| | 1) 100% | 2) 100% | Free vit, | vit, 100% | 5) 40% | 6) 40% |
| Phylum | Free | Pro | 40% Prot. mm | free min | Pro | Free |
| Firmicutes | 59.679% | 74.683% | 45.105% | 54.942% | 63.736% | 61.440% |
| Bacteroidetes | 35.204% | 20.395% | 51.639% | 41.822% | 32.718% | 31.058% |
| Tenericutes | 2.499% | 2.665% | 1.967% | 1.796% | 1.658% | 5.113% |
| Unassigned; Other | 0.229% | 0.187% | 0.192% | 0.204% | 0.060% | 0.329% |
| Actinobacteria | 0.131% | 0.090% | 0.094% | 0.104% | 0.091% | 0.050% |
| Cyanobacteria | 0.194% | 0.215% | 0.242% | 0.170% | 0.015% | 0.295% |
| Proteobacteria | 2.064% | 1.766% | 0.761% | 0.958% | 1.722% | 1.714% |
| TM7 | 0.000% | 0.000% | 0.000% | 0.004% | 0.000% | 0.000% |

### Example 5

Animals: 1,152 tagged one-day-old male chicks Ross708 assigned to 36 floor pens (32 birds/pen) and 1,152 female chicks assigned to another 36 pens were utilized in this study. Each pen was randomly assigned to one of 6 feed treatments as outlined in Table 12 below, with 12 replicate pens containing about 30 birds/treatment. Description of the vitamin and mineral supplementation levels of the respective free and protected treatments are shown in Table 13.

TABLE 12
Dietary Treatment Regimen

| | Vitamin Premix | | Mineral Premix | |
|---|---|---|---|---|
| | supplementation | | Supplementation | |
| | Level of | | Level of | |
| | supple- | | supple- | |
| Treatments | mentation | | mentation | |
| ID | (%) | Form | (%) | Form |
| 1 | 100 | Free | 100 | Free |
| 2 | 100 | Protected | 100 | Protected |
| 3 | 100 | Free | 30 | Protected |
| 4 | 30 | Protected | 100 | Free |
| 5 | 30 | Protected | 30 | Protected |
| 6 | 30 | Free | 30 | Free |

TABLE 13
Dietary levels of vitamins and trace minerals supplemented as free or protected premixes

| | Experimental Treatments | | | | | | | | | | | |
|---|---|---|---|---|---|---|---|---|---|---|---|---|
| Ingredients | 1 | | 2 | | 3 | | 4 | | 5 | | 6 | |
| Vitamin Premix | Biologically activity of Nutrient Expressed as the Unit per kg of Complete Diet | | | | | | | | | | | |
| Vitamin A Suppl. 1,000,000 | 10,000 | IU | 10,000 | IU | 10,000 | IU | 3,000 | | 3,000 | | 3,000 | |
| IU/g | | | | | | | | | | | | |
| Vitamin D3 Suppl. 500,000 | 4,500 | ICU | 4,500 | ICU | 4,500 | ICU | 1,350 | ICU | 1,350 | ICU | 1,350 | ICU |
| ICU/g | | | | | | | | | | | | |
| Vitamin E Suppl. 500 IU/g | 65 | IU | 65 | IU | 65 | IU | 19.5 | IU | 19.5 | IU | 19.5 | IU |
| Vitamin K3 MNB 43% | 3 | mg | 3 | mg | 3 | mg | 0.9 | mg | 0.9 | mg | 0.9 | mg |
| Thiamin Mononitrate | 2.5 | mg | 2.5 | mg | 2.5 | mg | 0.75 | mg | 0.75 | mg | 0.75 | mg |
| 76.92% | | | | | | | | | | | | |
| Riboflavin HCL 80% | 6.5 | mg | 6.5 | mg | 6.5 | mg | 1.95 | mg | 1.95 | mg | 1.95 | mg |
| Pyridoxine HCL 81.48% | 3.2 | mg | 3.2 | mg | 3.2 | mg | 0.96 | mg | 0.96 | mg | 0.96 | mg |
| d-Ca Pantothenate 91% | 18 | mg | 18 | mg | 18 | mg | 5.4 | mg | 5.4 | mg | 5.4 | mg |
| Folic acid 99% | 1.9 | mg | 1.9 | mg | 1.9 | mg | 0.57 | mg | 0.57 | mg | 0.57 | mg |
| Biotin 2% | 0.18 | mg | 0.18 | mg | 0.18 | mg | 0.054 | mg | 0.054 | mg | 0.054 | mg |
| Niacin 99% | 60 | mg | 60 | mg | 60 | mg | 18 | mg | 18 | mg | 18 | mg |
| Vitamin B12 1% | 0.017 | mg | 0.017 | mg | 0.017 | mg | 0.0051 | mg | 0.0051 | mg | 0.0051 | mg |
| Hydrogenated Fat Encaps. | 0 | g | 0.335 | g | 0 | g | 0.100 | g | .100 | g | 0 | g |
| Trace Mineral Premix | Biologically activity of Nutrient Expressed as the Unit per kg of Complete Diet | | | | | | | | | | | |
| EDDI, 79% I | .95 | mg | .95 | mg | 0.285 | mg | .95 | mg | 0.285 | mg | 0.285 | mg |
| Ferrous Sulfate, 30% Fe | 50 | mg | 50 | mg | 15 | mg | 50 | mg | 15 | mg | 15 | mg |
| Sodium Selenite, 45% Se | 0.3 | mg | 0.3 | mg | 0.09 | mg | 0.3 | mg | 0.09 | mg | 0.09 | mg |
| Zinc Oxide, 72% Zn | 85 | mg | 85 | mg | 25.5 | mg | 85 | mg | 25.5 | mg | 25.5 | mg |
| Manganese Oxide, 60% Mn | 85 | mg | 85 | mg | 25.5 | mg | 85 | mg | 25.5 | mg | 25.5 | mg |
| Copper Sulfate, 25% Cu | 10 | mg | 10 | mg | 3 | mg | 10 | mg | 3 | mg | 3 | mg |
| Hydrogenated Fat Encaps. | 0 | g | 0 532 | g | 0.160 | g | 0 | g | 0.160 | g | 0 | g |

| Other Ingredients | Grams per Kg of Complete Diet | | | | | | | |
|---|---|---|---|---|---|---|---|---|
| Hydrogenated Veg. Fat¹ | 0.867 | 0 | 0.335 | 0.532 | g | 0 | 0.260 | g |

| | | | | | | |
|---|---|---|---|---|---|---|
| Vermiculite carrier | 0.400 | 0.400 | 0.290 | 0.290 | 0.120 | 0.120 |

¹Hydrogenated Vegetable oil was added on the vermiculite carrier in the free vitamin or mineral premixes to equate the amount of hydrogenated vegetable fat used to encapsulate the vitamins and minerals in the protected premixes.

Methods: All birds were challenged with the commercial recommended dose of coccidia vaccine at placement. Birds were fed one of six diets ad libitutn. The basal corn-soybean meal diets were formulated to meet the requirements for Ross 708 broilers as recommended by Aviagen for the starter (1-14 d), grower (15-28 d), and finisher (29-42 d). Pen weight and feed consumption was measured by pen at 14 and 28 days of age, while individual body weights were determined at day 42. The amounts of feed supplied and feed residues were recorded to calculate feed intake and feed conversion ratio by pen.

Skin pigmentation and breast meat color are important qualitative characteristics that impact the economic value and consumer preference of poultry products. Shank and breast skin color and breast meat color were determined using a Minolta colorimeter (L*a*b*). The objective for these studies was to determine if vitamin and mineral premix form (free versus protected) and dietary level of vitamin and mineral premix supplementation (100% versus 30%), allows for improved growth performance and processing. Three treatments were evaluated: treatment 1 (100% free Vitamins+Minerals), 5 (30% protected vitamins+minerals), and 6 (30% free vitamins+minerals). Five birds per pen representing the mean body weight+/−standard deviation were selected for slaughter and carcass cut up yield and meat quality measurements. Broilers were slaughtered and processed according to standard commercial protocols and the eviscerated carcasses were chilled in water until 4° C., where they remained over night. Skin and breast meat color was determined by the Minolta colorimeter (L, a*, b* values), and the major beast muscle was scored for white striping and wooden breast. A sample of the breast meat was also sampled to determine drip loss by hanging a piece of meat on a hook in a sealed moisture impermeable bag, or wrapped in a moisture-wicking pad. Paw quality (foot and hock burn scores) were also recorded.

All data were statistically analyzed using SMP Pro 13 via the GLM Procedure. Significant differences between treatment groups were determined via Tukey HSD (p≤0.05) and differences from the control (treatment 1) were determined using Dunnett's test. To compare the protected and free forms, a t-test was used to analyze differences between treatments 5 and 6. A t-test was also used to compare the free form of the 100% and 30% treatment groups to determine if differences are due to the level of premix. To determine the main effects and interaction effects of vitamin and mineral premix form (free versus protected) and premix supplementation level (100% versus 43%), factorial analysis was done using only treatments 1, 2, 5 and 6.

Results: Growth Performance of Female Broilers

Because male and female broilers were raised in separate pens, body weights, feed intake, and feed conversion ratios were determined by sex on days 14, 28 and 42. There were no significant treatments effects observed among the female broilers for feed intake (Table 14), body weight (Table 15), and feed conversion ratio (Table 16).

TABLE 14
Effect of dietary level and form of vitamin
and mineral premix supplementation on feed
intake (kg) of Female Ross 708 boiler chickens

| Treatment | 0-14 days | 0-28 days | 0-42 days |
|---|---|---|---|
| 1) 100% Free V + M | 0.585 | 2.098 | 4.036 |
| 2) 100% Prot V + M | 0.593 | 2.110 | 4.010 |
| 3) 100% Free V + 30% Prot. M | 0.588 | 2.130 | 4.057 |
| 4) 30% Prot V + 100% Free M | 0.590 | 2.088 | 3.894 |
| 5) 30% Prot V + M | 0.593 | 2.110 | 4.010 |
| 6) 30% Free V + M | 0.585 | 2.130 | 4.070 |
| P value | 0.7639 | 0.3552 | 0.3680 |
| Source of Variation¹ | (P value) | | |
| Premix Level (100% vs 30%) | 0.46 | 0.64 | 0.63 |
| Premix Form (Free vs Protected) | 0.46 | 0.75 | 0.91 |
| Level X Form | 0.38 | 0.13 | 0.21 |
| SEM | 0.002 | 0.008 | 0.02 |

¹Source of Variation is described for the factorial analysis of 2 premix forms (Free and Protected) X 2 Premix levels (100 and 30%), from data presented by treatments 1, 2, 5, and 6.

TABLE 15
Effect of dietary level and form of vitamin
and mineral premix supplementation on body
weight (kg) of Female Ross 708 boiler chickens

| Treatment | 14 days | 28 days | 42 days |
|---|---|---|---|
| 1) 100% Free V + M | 0.523 | 1.557 | 2.540 |
| 2) 100% Prot V + M | 0.517 | 1.571 | 2.565 |
| 3) 100% Free V + 30% Prot. M | 0.517 | 1.563 | 2.520 |
| 4) 30% Prot V + 100% Free M | 0.512 | 1.523 | 2.514 |
| 5) 30% Prot V + M | 0.524 | 1.531 | 2.492 |
| 6) 30% Free V + M | 0.507 | 1.542 | 2.532 |
| P value | 0.1987 | 0.3159 | 0.8808 |
| Source of Variation¹ | (P value) | | |
| Premix Level (100% vs 30%) | 0.44 | 0.11 | 0.24 |
| Premix Form (Free vs Protected) | 0.35 | 0.92 | 0.83 |
| Level X Form | 0.06 | 0.45 | 0.35 |
| SEM | 0.003 | 0.008 | 0.02 |

¹Source of Variation is described for the factorial analysis of 2 premix forms (Free and Protected) X 2 Premix levels (100 and 30%), from data presented by treatments 1, 2, 5, and 6.

TABLE 16
Effect of dietary level and form of vitamin and mineral premix
supplementation on Feed Conversion Ratio (Feed/Gain, adjusted
for mortality) of female Ross 708 boiler chickens

| Treatment | 14 days | 28 days | 42 days |
|---|---|---|---|
| 1) 100% Free V + M | 1.21 | 1.38 | 1.61 |
| 2) 100% Prot V + M | 1.22 | 1.39 | 1.62 |
| 3) 100% Free V + 30% Prot. M | 1.23 | 1.40 | 1.63 |
| 4) 30% Prot V + 100% Free M | 1.25 | 1.39 | 1.58 |
| 5) 30% Prot V + M | 1.22 | 1.40 | 1.62 |
| 6) 30% Free V + M | 1.25 | 1.41 | 1.64 |
| P value | 0.2900 | 0.6967 | 0.6302 |
| Source of Variation¹ | (P value) | | |
| Premix Level (100% vs 30%) | 0.16 | 0.18 | 0.42 |
| Premix Form (Free vs Protected) | 0.66 | 1.00 | 0.87 |
| Level X Form | 0.24 | 0.34 | 0.46 |
| SEM | 0.008 | 0.006 | 0.01 |

¹Source of Variation is described for the factorial analysis of 2 premix forms (Free and Protected) X 2 Premix levels (100 and 30%), from data presented by treatments 1, 2, 5, and 6.

Results: Growth Performance of Male Broilers

Because of their more aggressive growth rate, males are more sensitive to nutritional constraints than females. Some significant treatment effects were observed in growth performance among the male broilers (Tables 17-19). Significant treatment effects were observed for several key growth performance indicators among the male broilers, particularly as related to the form of vitamin and trace mineral premixes (Free versus protected) and the supplementation level of vitamin and mineral premixes. There were no significant form X level interaction effects observed on feed intake, but a few main effects were observed (Table 17). During the 0-28 d period, feed intake decreased as the supplementation level decreased, but this effect did not continue through to 42 days of age. Feed intake was significantly lower for the protected vitamin and mineral premixes during the growing (0-28 days) and finishing (0-42 days) period. It is particularly noteworthy that this decrease in feed intake in birds fed the protected vitamins and trace mineral premixes was not accompanied by a similar significant decrease in body weight (Table 18), which indicates significant reduction in feed input costs. Only 14-day body weight was only reduced significantly as the level of vitamin and mineral supplementation decreased, regardless of the form of premix. Dietary treatment effects on overall (0-42 d) feed conversion ratio are shown in Table 19. Although there were no significant main effects of premix supplementation level or form, a highly significant premix form X supplementation level was observed. At the 100% level of premix supplementation, the protected vitamin and mineral premixes improved adjusted feed conversion ratio (FCR) by an astounding 12 points (1.68 vs 1.56), whereas at the 30% supplementation level premix form had no significant effect on FCR. In conclusion, protecting vitamin and mineral premixes by hydrogenated fat encapsulation results in favorable growth performance results, perhaps by slowing the release of these nutrients to prevent the proliferation of competitive microflora.

TABLE 17
Effect of dietary level and form of vitamin
and mineral premix supplementation on feed
intake (kg) of Male Ross 708 boiler chickens

| Treatment | 0-14 days | 0-28 days | 0-42 days |
|---|---|---|---|
| 1) 100% Free V + M | 0.582 | 2.387 | 4.697 |
| 2) 100% Prot V + M | 0.589 | 2.355 | 4.449 |
| 3) 100% Free V + 30% Prot. M | 0.593 | 2.359 | 4.722 |
| 4) 30% Prot V + 100% Free M | 0.584 | 2.311 | 4.562 |
| 5) 30% Prot V + M | 0.588 | 2.287 | 4.577 |
| 6) 30% Free V + M | 0.588 | 2.352 | 4.642 |
| P value | 0.8666 | 0.1492 | 0.1114 |
| Source of Variation¹ | (P value) | | |
| Premix Level (100% vs 30%) | 0.72 | 0.04 | 0.58 |
| Premix Form (Free vs Protected) | 0.50 | 0.05 | 0.02 |
| Level X Form | 0.52 | 0.48 | 0.16 |
| SEM | 0.003 | 0.012 | 0.032 |

¹Source of Variation is described for the factorial analysis of 2 premix forms (Free and Protected) X 2 Premix levels (100 and 30%), from data presented by treatments 1, 2, 5, and 6.

TABLE 18
Effect of dietary level and form of vitamin
and mineral premix supplementation on body
weight (kg) of Male Ross 708 boiler chickens

| Treatment | 14 days | 28 days | 42 days |
|---|---|---|---|
| 1) 100% Free V + M | 0.549 | 1.742 | 2.885 |
| 2) 100% Prot V + M | 0.537 | 1.669 | 2.887 |
| 3) 100% Free V + 30% Prot. M | 0.539 | 1.734 | 3.099 |
| 4) 30% Prot V + 100% Free M | 0.534 | 1.720 | 2.936 |
| 5) 30% Prot V + M | 0.537 | 1.669 | 2.887 |
| 6) 30% Free V + M | 0.533 | 1.729 | 3.065 |
| P value | 0.4977 | 0.3891 | 0.0541 |
| Source of Variation¹ | (P value) | | |
| Premix Level (100% vs 30%) | 0.04 | 0.16 | 0.11 |
| Premix Form (Free vs Protected) | 0.88 | 0.21 | 0.12 |
| Level X Form | 0.42 | 0.34 | 0.06 |
| SEM | 0.003 | 0.013 | 0.024 |

¹Source of Variation is described for the factorial analysis of 2 premix forms (Free and Protected) X 2 Premix levels (100 and 30%), from data presented by treatments 1, 2, 5, and 6.

TABLE 19
Effect of dietary level and form of vitamin and mineral premix
supplementation on Feed Conversion Ratio (Feed/Gain, adjusted
for mortality) of Male Ross 708 boiler chickens

| Treatment | 14 days | 28 days | 42 days |
|---|---|---|---|
| 1) 100% Free V + M | 1.14 | 1.37 | 1.68 |
| 2) 100% Prot V + M | 1.17 | 1.36 | 1.56 |
| 3) 100% Free V + 30% Prot. M | 1.19 | 1.36 | 1.59 |
| 4) 30% Prot V + 100% Free M | 1.18 | 1.36 | 1.60 |
| 5) 30% Prot V + M | 1.18 | 1.37 | 1.64 |
| 6) 30% Free V + M | 1.19 | 1.37 | 1.59 |
| P value | 0.4108 | 0.8764 | 0.0505 |
| Source of Variation¹ | (P value) | | |
| Premix Level (100% vs 30%) | 0.07 | 0.84 | 0.87 |
| Premix Form (Free vs Protected) | 0.50 | 0.54 | 0.18 |
| Level X Form | 0.29 | 0.45 | 0.007 |
| SEM | 0.008 | 0.006 | 0.013 |

¹Source of Variation is described for the factorial analysis of 2 premix forms (Free and Protected) X 2 Premix levels (100 and 40%), from data presented by treatments 1, 2, 5, and 6.

Broiler Processing and Meat/Skin Quality Evaluation

Carcass cut up yield; and pigmentation of skin and breast meat are important qualitative characteristic that impact the economic value and consumer preference of poultry products. Three treatments were evaluated: treatment 1 (100% free Vitamins+Minerals), 5 (30% protected vitamins+minerals), and 6 (30% free vitamins+minerals). Since there were no significant treatment effects on body weights, carcass parts yield were expressed as actual weights for carcass parts than as a percentage of live weight or eviscerated carcass. All cuts resulted in similar weights except the breast meat (the most valuable part of the chicken), where the 30% level of supplementation resulted in heavier breast meat than the 100% supplementation level, and encapsulation had little additional benefit (Table 20).

Paw quality was analyzed to determine color changes in the shank as well as ammonia burns on the shank and hawk. Significant differences were found in the b* measurements between the 100% free and 30% free, indicating that the 30% protected had similar b* measurements (more yellow color) to the 100% free forms. The 30% protected treatments had similar recovery of hawk ammonia burns to the 100% free, both of which have greater instance of recovery in comparison to the 30% free (Table 21). This indicates that the protective coating maintains the “yellow” color of the shank with decreased supplementation level of the premix.

TABLE 20
Effect of dietary level and form of vitamin and mineral premix supplementation
on carcass parts yield of Male Ross 708 boiler chickens at 42 days of age.

| | 100% Free Vitamins and | 30% Protected Vitamins and | | 30% Free Vitamins and | |
|---|---|---|---|---|---|
| | Minerals (Treatment 1) | Minerals (Treatment 5) | | Minerals (Treatment 6) | |
| Parts | mean ± st. error | mean ± st. error | p-value | mean ± st. error | p-value |
| wings | 0.3 ± 0.004 | 0.3 ± 0.004 | 0.71 | 0.3 ± 0.004 | 0.9983 |
| thighs | 0.513 ± 0.009 | 0.51 ± 0.009 | 0.8 | 0.515 ± 0.01 | 0.99 |
| drumsticks | 0.38 ± 0.005 | 0.37 ± 0.005 | 0.46 | 0.38 ± 0.005 | 0.59 |
| breast meat | 0.87 ± 0.011^{b} | 0.89 ± 0.011^{ab} | 0.31 | 0.91 ± 0.011^{a} | 0.045¹ |
| tenders | 0.17 ± 0.003 | 0.17 ± 0.003 | 0.9 | 0.16 ± 0.003 | 0.72 |
| residual rack | 0.83 ± 0.015 | 0.81 ± 0.015 | 0.43 | 0.82 ± 0.015 | 0.84 |
| skin | 0.09 ± 0.004 | 0.09 ± 0.004 | 0.97 | 0.09 ± 0.004 | 0.81 |

¹P value of significance relative to control treatment 1 using the Dunnett's test.

TABLE 21
Effect of dietary level and form of vitamin and mineral premix supplementation on
paw quality analysis of Male Ross 708 boiler chickens at 42 days of age.
Paw Quality After Processing

| | 100% Free V + M | 30% Protected V + M | | 30% Free V + M | |
|---|---|---|---|---|---|
| | (Treatment 1) | (Treatment 5) | | (Treatment 6) | |
| | mean ± st. error | mean ± st error | p-value | mean ± st. error | p-value |
| L* | 75.05 ± 0.38 | 75.24 ± 0.37 | 0.92 | 75.56 ± 0.36 | 0.53 |
| a* | (−0.78) ± 0.24 | (−0.38) ± 0.23 | 0.38 | 0.22 ± 0.22 | 0.9995 |
| b* | 38.38 ± 0.7^{a} | 36.58 ± 0.68^{ab} | 0.12 | 35.09 ± 0.66^{b} | 0.002¹ |
| Shank Score (0-3) | 1.02 ± 0.1 | 1.07 ± 0.1 | 0.91 | 1.13 ± 0.09 | 0.63 |
| Hawk Score (0 or 1) | 0.44 ± 0.07 | 0.41 ± 0.06 | 0.93 | 0.61 ± 0.06 | 0.1 |

¹P value of significance relative to control treatment 1 using the Dunnett's test.

Breast skin and meat were analyzed through a colorimeter as well as subjectively palpated for white striping and wooden breast. No significant differences were identified with the breast skin color, but increased a* and b* values were found in the protected group, indicating that the coated premix allows for a skin color that is more “red” and “yellow” in comparison to the free form treatments (Table 22). Significantly higher values of b* were found with the protected treatment, indicating increased “red” color to the breast meat (Table 23). There was significantly lower recovery of b* values for 100% free and the protected had the largest b* value, indicating that the greatest “yellow” color is from the protected group. All groups had similar scores for white striping and wooden breast.

TABLE 22
Effect of dietary level and form of vitamin and mineral premix supplementation on
breast skin color of Male Ross 708 boiler chickens at 42 days of age.
Breast Skin Colorimeter

| | 100% Free V + M | 30% Protected V + M | | 30% Free V + M | |
|---|---|---|---|---|---|
| | (Treatment 1) | (Treatment 5) | | (Treatment 6) | |
| | mean ± st. error | mean ± st. error | p-value | mean ± st. error | p-value |
| L* | 72.82 ± 0.50 | 71.38 ± 0.50 | 0.082 | 71.84 ± 0.5 | 0.29 |
| a* | 4.76 ± 0.47 | 5.34 ± 0.46 | 0.58 | 4.93 ± 0.46 | 0.95 |
| b* | 12.34 ± 0.63 | 13.55 ± 0.61 | 0.29 | 12.02 ± 0.62 | 0.91 |

TABLE 23
Effect of dietary level and form of vitamin and mineral premix supplementation
breast meat color and my opathy (White stripping and wooden breasts)
of Male Ross 708 boiler chickens at 42 days of age.
Breast Meat Colorimeter, white striping and wooden breast scores

| | 100% Free | 30% Protected | | 30% Free | |
|---|---|---|---|---|---|
| | mean ± st. error | mean ± st. error | p-value | mean ± st. error | p-value |
| L* | 63.75 ± 0.64 | 63.65 ± 0.65 | 0.99 | 63.86 ± 0.64 | 0.06 |
| a* | 2.47 ± 0.3^{b} | 3.4 ± 0.3^{a} | 0.59 | 2.44 ± 0.3^{b} | 0.9954 |
| b* | 7 ± 0.45^{b} | 8.95 ± 0.46^{a} | 0.006 | 8.57 ± 0.45^{a} | 0.03 |
| White Striping | 2.13 ± 0.12 | 2.17 ± 0.13 | 0.97 | 2.3 ± 0.12 | 0.54 |
| Wooden Breast | 1.93 ± 0.12 | 2.07 ± 0.13 | 0.66 | 2.07 ± 0.12 | 0.67 |

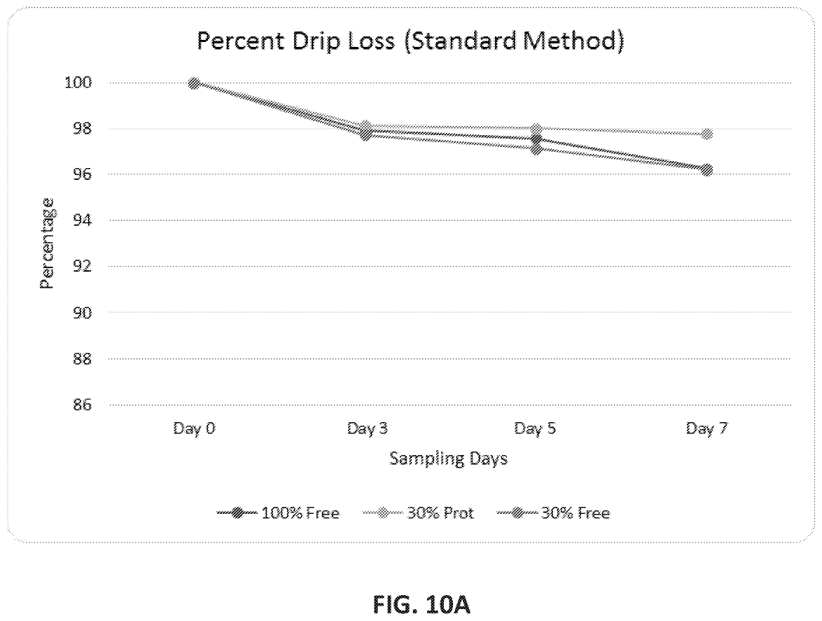

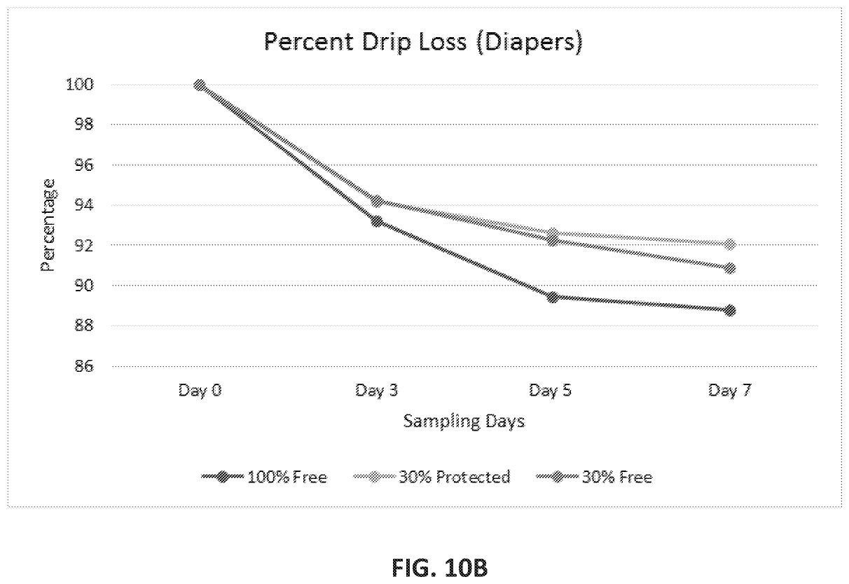

Breast meat drip loss analysis was performed via two techniques: the “standard”, in which breast meat was hung on a hook with a bag surrounding it to collect liquid that was lost from the meat; and the “diaper” technique, in which breast meat was surrounded by a diaper to wick liquid away from the meat. The first technique was used to determine drip loss from an industry standard, while the second is a new approach that determines how well the proteins in the meat are able to maintain moisture during prolonged packed storage and handling. Using the standard drip loss method, drip loss during cool storage from day 5-7 was significantly less (>1%) from the breast meat among broilers fed the protected vitamin and mineral premix at the 300/0 level of supplementation than the broilers fed the free vitamin and mineral premixes, regardless of supplementation level (FIG. 10A). A similar moisture retention benefit was observed using the diaper wrap method for the breast meat from birds fed the 30% level of protected vitamin and mineral premix (FIG. 10B). These results show that protecting the vitamin and mineral premixes by hydrogenated fat encapsulation helps prevent meat tissue degradation during 7 days of storage and thus helps retain moisture, which is a highly valuable trait for meat processors and value-added breast meat food products.

### Conclusions from Examples 4-5

Dietary level of vitamin and trace mineral supplementation and encapsulation of vitamins and minerals had no significant effect of body weight.

For example 5, males had no change in body weights for days 28 and 42; however, feed intake was significantly less for the reduced and protected treatments on day 28 and for the protected diets on day 42. It can be inferred that the protected vitamins and trace minerals diets allowed for improved nutrient utilization to convert feed to meat.

For example 5, males at day 42 FCR of protected V+M 100% was 12 points better in FCR than the free form of the vitamins and trace minerals when supplemented at 100% of industry standard where a level X form effect was identified. However, even the protected vitamins and trace minerals at 30% of industry standard had 5 points better FCR than the 100% of free vitamins and trace minerals. This indicates that encapsulation improved caloric and nutrient utilization, even when the vitamins and trace minerals are supplemented at only 30% of the industry standard dose.

Protecting the vitamin and trace mineral premixes by hydrogenated fat encapsulation improves jejunum mucosal health, as indicated by significant reductions in villi tip width, crypt depth, and villi surface area, regardless of the level of supplementation.

Protection of vitamins and/or trace minerals by hydrogenated fat encapsulation will alter the gut microflora towards a population distribution that is more symbiotic with the host. The protected vitamin and mineral treatment favored the proliferation of Firmicutes, which are generally symbiotic with the host animal, but suppressed Bacteriodetes, Tenericutes, and Proteiobacteria, which are more competitive and typically include many of the pathogens that cause enteric disease.

Shank color (yellowness) at 42 days of age was maintained with the 30% level of protected vitamins and trace minerals as when fed at the 100% industry standard levels, whereas 30% level of free vitamins and trace minerals had reduced shank color. This indicates that protection by hydrogenated fat encapsulation of vitamins and minerals will help maintain carotenoid pigment absorption, which is dependent on gut health and absorptive capacity.

As observed with improvements in shank color, breast skin and breast meat color score is improved (more red and yellow) by encapsulated vitamins and minerals, even at low dosage levels, indicating improved carotenoid pigment absorption and improved gut health.

Moisture drip loss of meat over 5 to 7 days is significantly lower with 30% encapsulated V+M than all other treatments, which indicates reduced oxidative damage of muscle tissues. This measure indicates that the breast meat would retain more moisture during storage, processing, and cooking.

Hock burn score of 100% supplementation level of protected vitamin and mineral premixes was same as the 100% free vitamin and mineral premix treatments, but much lower than 30% supplementation level of free vitamins and minerals. Protection of vitamins and trace minerals, even at 30% of industry standard, either improved resistance to foot lesions, improved leg health and mobility, or improved litter quality that is associated with foot pad or hock lesions.

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

1. A composition for feeding a chicken, the composition comprising:
a controlled release lipid matrix consisting of (a) at least one hydrogenated vegetable triglyceride selected from the group consisting of palm butter, sunflower oil, corn oil, rape oil, peanut oil and soybean oil; or (b) at least one animal triglyceride selected from the group consisting of bovine tallow and swine lard; and
one or more nutrients encapsulated within the controlled release lipid matrix, wherein each of the one or more nutrients is selected from the group consisting of a vitamin, a mineral, and an amino acid.

2. The composition according to claim 1, wherein the one or more nutrients comprise
one or more vitamins selected from the group consisting of vitamin A, vitamin E, vitamin D3, vitamin C, vitamin K, vitamin B1 (thiamin), vitamin B2 (riboflavin), vitamin B3 (niacin), choline, vitamin B3 (panthothenic acid), vitamin B6 (pyridoxine), biotin, inositol, vitamin B9 (folic acid), vitamin B10 (para amino benzoic acid), vitamin B12 (cyano cobalamin), and beta-carotene;
one or more minerals selected from the group consisting of cobalt, copper, selenium, iodine, iron, manganese, magnesium, sulfur, zinc, calcium, sodium, potassium, and phosphorus;
one or more amino acids selected from the group consisting of alanine, arginine, asparagine, aspartic acid, cysteine, glutamine, glutamic acid, glycine, histidine, isoleucine, lysine, methionine, phenylalanine, proline, serine, threonine, tryptophan, tyrosine, and valine;
and combinations thereof.

3. A method for feeding a chicken, the method comprising:
mixing the composition of claim 1 with chicken feed to form a supplemented chicken feed; and
orally administering the supplemented chicken feed to the chicken.

4. The method of claim 3, wherein the supplemented chicken feed comprises one or more vitamins selected from the group consisting of vitamin A in an amount from about 3,000 to about 25,000 IU per kg of the supplemented chicken feed, vitamin D3 in an amount from about 1,000 to about 5,000 IU per kg of the supplemental chicken feed, vitamin E in an amount from about 15 to about 200 IU per kg of the supplemented chicken feed, vitamin B1 (thiamin) in an amount from about 0.5 to about 5 mg per kg of the supplemented chicken feed, vitamin B2 (riboflavin) in an amount from about 1.0 to about 20 mg per kg of the supplemented chicken feed, vitamin B3 (niacin) in an amount from about 15 to about 150 mg per kg of the supplemented chicken feed, choline in an amount from about 200 to about 2000 mg per kg of the supplemental chicken feed, vitamin B5 (pantothenic acid) in an amount from about 5.0 to about 50 mg per kg of the supplemented chicken feed, vitamin B6 (pyroxidone) in an amount from about 0.5 to about 10.0 mg per kg of the supplemented chicken feed, biotin in an amount from about 0.05 to about 1.0 mg per kg of the supplemented chicken feed, inositol in an amount from about 500 mg per kg to about 5,000 mg per kg of the supplemented chicken feed, vitamin B9 (folic acid) in an amount from about 0.5 to about 5.0 mg per kg of the supplemented chicken feed, vitamin B10 (para amino benzoic acid) in an amount from about 50 mg per kg to about 1,000 mg per kg of the supplemented chicken feed, vitamin B12 (cyano cobalamin) in an amount from about 0.003 to about 0.05 mg per kg of the supplemented chicken feed, vitamin K3 in an amount from about 0.5 to about 5.0 mg per kg of the supplemented chicken feed, beta-carotene in an amount from about 500 to about 20,000 mg per kg of the supplemented chicken feed, and vitamin C in an amount from about 20 to about 200 mg per kg of the supplemented chicken feed.

5. The method of claim 3, wherein the supplemented chicken feed comprises one or more vitamins selected from the group consisting of vitamin A in an amount from about 2,000 to about 4,000 IU per kg of the supplemented chicken feed, vitamin D3 in an amount from about 1,000 to about 2,000 IU per kg of the supplemented chicken feed, vitamin E in an amount from about 15 to about 25 IU per kg of the supplemented chicken feed, vitamin B1 (thiamin) in an amount from about 0.5 to about 1.0 mg per kg of the supplemented chicken feed, vitamin B2 (riboflavin) in an amount from about 1.0 to about 2.3 mg per kg of the supplemented chicken feed, vitamin B3 (niacin) in an amount from about 15 to about 25 mg per kg of the supplemented chicken feed, choline in an amount from about 200 to about 800 mg per kg of the supplemented chicken feed, vitamin B5 (pantothenic acid) in an amount from about 5.0 to about 10.0 mg per kg of the supplemented chicken feed, vitamin B6 (pyroxidone) in an amount from about 0.5 to about 2.0 mg per kg of the supplemented chicken feed, biotin in an amount from about 0.05 to about 0.10 mg per kg of the supplemented chicken feed, inositol in an amount from about 500 mg per kg to about 1000 mg per kg of the supplemented chicken feed, vitamin B9 (folic acid) in an amount from about 0.50 to about 1.0 mg per kg of die supplemented chicken feed, vitamin B10 (para amino benzoic acid) in an amount from about 50 mg per kg to about 200 mg per kg of the supplemented chicken feed, vitamin B12 (cyano cobalamin) in an amount from about 0.003 to about 0.007 mg per kg of the supplemented chicken feed, vitamin K3 in an amount from about 0.5 to about 1.5 mg per kg of the supplemented chicken feed, beta-carotene in an amount from about 500 to about 4,000 mg per kg of the supplemented chicken feed, and vitamin C in an amount from about 20 to about 100 per kg of the supplemented chicken feed.

6. The method of claim 3, wherein the supplemented chicken feed comprises one or more minerals selected from the group consisting of cobalt in an amount from about 0.20 to 5 mg per kg of the supplemented chicken feed, copper in an amount from about 2.0 to 20 mg per kg of the supplemented chicken feed, selenium in an amount from about 0.05 to 0.30 mg per kg of the supplemented chicken feed, iodine in an amount from about 0.25 to 5.0 mg per kg of the supplemented chicken feed, iron in an amount from about 10 to 100 mg per kg of the supplemented chicken feed, manganese in an amount from about 15 to 150 mg per kg of the supplemented chicken feed, zinc in an amount from about 15 to 1500 mg per kg of the supplemented chicken feed, calcium in an amount from about 5,000 to 20,000 mg per kg of the supplemented chicken feed, sodium in an amount from about 500 to 2,500 mg per kg of the supplemented chicken feed, potassium in an amount from about 2,000 to 10,000 mg per kg of the supplemented chicken feed, phosphorus in an amount from about 1000 to 10,000 mg per kg of the supplemented chicken feed, and magnesium in an amount from about 100 to about 500 mg per kg of the supplemented chicken feed.

7. The method of claim 3, wherein the supplemented chicken feed comprises one or more minerals selected from the group consisting of cobalt in an amount from about 0.20 to 1.0 mg per kg of the supplemented chicken feed, copper in an amount from about 2.0 to 5.0 mg per kg of the supplemented chicken feed, selenium in an amount from about 0.05 to 0.2 mg per kg of the supplemented chicken feed, iodine in an amount from about 0.25 to 0.5 mg per kg of the supplemented chicken feed, iron in an amount from about 10 to 40 mg per kg of the supplemented chicken feed, manganese in an amount from about 15 to 50 mg per kg of the supplemented chicken feed, zinc in an amount from about 15 to 50 mg per kg of the supplemented chicken feed, calcium in an amount from about 5,000 to 10,000 mg per kg of the supplemented chicken feed, sodium in an amount from about 500 to 1,000 mg per kg of the supplemented chicken feed, potassium in an amount from about 2,000 to 5,000 mg per kg of the supplemented chicken feed, phosphorus in an amount from about 1000 to 4,000 mg per kg of the supplemented chicken feed, and magnesium in an amount from about 100 to about 200 mg per kg of the supplemented chicken feed.

8. The method of claim 3, wherein the supplemented chicken feed comprises one or more amino acids selected from the group consisting of alanine in an amount from about 2 to about 10 g per kg of the supplemented chicken feed, arginine in an amount from about 2 to about 10 g per kg, asparagine in an amount from about 3 to about 15 g per kg, aspartic acid in an amount from about 3 to about 15 g per kg, cysteine in an amount from about 0.5 to about 2.5 g per kg, glutamine in an amount from about 4 to about 20 g per kg, glutamic acid in an amount from about 3 to about 15 g per kg, glycine in an amount from about 2.5 to about 12 g per kg, histidine in an amount from about 0.5 to about 12 g per kg, isoleucine in an amount from about 0.6 to about 3 g per kg, lysine in an amount from about 2 to about 10 g per kg, methionine in an amount from about 1 to about 6 g per kg, phenylalanine in an amount from about 1 to about 5 g per kg, proline in an amount from about 2.5 to about 12 g per kg, serine in an amount from about 1 to about 5 g per kg, threonine in an amount from about 1 to about 5 g per kg, tryptophan in an amount from about 0.5 to about 3.5 g per kg, tyrosine in an amount from about 1 to about 5 g per kg, and valine in an amount from about 0.6 to about 3 mg per kg.

9. The method of claim 3, wherein the supplemented chicken feed comprises one or more amino acids selected from the group consisting of alanine in an amount from about 2 to about 7 g per kg of the supplemented chicken feed, arginine in an amount from about 2 to about 7 g per kg, asparagine in an amount from about 3 to about 10 g per kg, aspartic acid in an amount from about 3 to about 10 g per kg, cysteine in an amount from about 0.5 to about 2 g per kg, glutamine in an amount from about 4 to about 14 g per kg, glutamic acid in an amount from about 3 to about 10 g per kg, glycine in an amount from about 2.5 to about 8 g per kg, histidine in an amount from about 0.5 to about 1.5 g per kg, isoleucine in an amount from about 0.5 to about 2 g per kg, lysine in an amount from about 2 to about 7 g per kg, methionine in an amount from about 1.2 to about 4.2 g per kg, phenylalanine in an amount from about 1 to about 3.5 g per kg, proline in an amount from about 2.5 to about 8.5 g per kg, serine in an amount from about 1 to about 3.5 g per kg, threonine in an amount from about 1 to about 3.5 g per kg, tryptophan in an amount from about 0.5 to about 2.5 g per kg, tyrosine in an amount from about 1 to about 3.5 g per kg, and valine in an amount from about 0.5 to about 2 g per kg.

10. (canceled)

11. Use of the composition of claim 1 in the manufacture of a supplemented chicken feed.

12. Use of the composition of claim 1, in combination with chicken feed, for manufacturing a supplemented chicken feed.

13. The use of claim 11, wherein the supplemented chicken feed comprises one or more vitamins selected from the group consisting of vitamin A in an amount from about 3,000 to about 25,000 IU per kg of the supplemented chicken feed, vitamin D3 in an amount from about 1,000 to about 5,000 IU per kg of the supplemented chicken feed, vitamin E in an amount from about 15 to about 200 IU per kg of the supplemented chicken feed, vitamin B1 (thiamin) in an amount from about 0.5 to about 5 mg per kg of the supplemented chicken feed, vitamin B2 (riboflavin) in an amount from about 1.0 to about 20 mg per kg of the supplemented chicken feed, vitamin B3 (niacin) in an amount from about 15 to about 150 mg per kg of the supplemented chicken feed, choline in an amount from about 200 to about 2000 mg per kg of the supplemented chicken feed, vitamin B5 (pantothenic acid) in an amount from about 5.0 to about 50 mg per kg of the supplemented chicken feed, vitamin B6 (pyroxidone) in an amount from about 0.0.5 to about 10.0 mg per kg of the supplemented chicken feed, biotin in an amount from about 0.05 to about 1.0 mg per kg of the supplemented chicken feed, inositol in an amount from about 500 mg per kg to about 5,000 mg per kg of the supplemented chicken feed, vitamin B9 (folic acid) in an amount from about 0.5 to about 5.0 mg per kg of the supplemented chicken feed, vitamin B10 (para amino benzoic acid) in an amount from about 50 mg per kg to about 1,000 mg per kg of the supplemented chicken feed, vitamin B12 (cyano cobalamin) in an amount from about 0.003 to about 0.05 mg per kg of the supplemented chicken feed, vitamin K3 in an amount from about 0.5 to about 5.0 mg per kg of the supplemented chicken feed, beta-carotene in an amount from about 500 to about 20,000 mg per kg of the supplemented chicken feed, and vitamin C in an amount from about 20 to about 200 mg per kg of the supplemented chicken feed.

14. The use of claim 11, wherein the supplemented chicken feed comprises one or more vitamins selected from the group consisting of vitamin A in an amount from about 2,000 to about 4,000 IU per kg of the supplemented chicken feed, vitamin D3 in an amount from about 1,000 to about 2,000 IU per kg of the supplemented chicken feed, vitamin E in an amount from about 15 to about 25 IU per kg of the supplemented chicken feed, vitamin B1 (thiamin) in an amount from about 0.5 to about 1.0 mg per kg of the supplemented chicken feed, vitamin B2 (riboflavin) in an amount from about 1.0 to about 2.5 mg per kg of the supplemented chicken feed, vitamin B3 (niacin) in an amount from about 15 to about 25 mg per kg of the supplemented chicken feed, choline in an amount from about 200 to about 800 mg per kg of the supplemented chicken feed, vitamin B5 (pantothenic acid) in an amount from about 5.0 to about 10.0 mg per kg of the supplemented chicken feed, vitamin B6 (pyroxidone) in an amount from about 0.5 to about 2.0 mg per kg of the supplemented chicken feed, biotin in an amount from about 0.05 to about 0.10 mg per kg of the supplemented chicken feed, inositol in an amount from about 500 mg per kg to about 1000 mg per kg of the supplemented chicken feed, vitamin B9 (folic acid) in an amount from about 0.50 to about 1.0 mg per kg of the supplemented chicken feed, vitamin B10 (para amino benzoic acid) in an amount from about 50 mg per kg to about 200 mg per kg of the supplemented chicken feed, vitamin B12 (cyano cobalamin) in an amount from about 0.003 to about 0.007 mg per kg of the supplemented chicken feed, vitamin K3 in an amount from about 0.5 to about 1.5 mg per kg of the supplemented chicken feed, beta-carotene in an amount from about 500 to about 4,000 mg per kg of the supplemented chicken feed, and vitamin C in an amount from about 20 to about 100 per kg of the supplemented chicken feed.

15. The use of claim 11, wherein the supplemented chicken feed comprises one or more minerals selected from the group consisting of cobalt in an amount from about 0.20 to 5 mg per kg of the supplemented chicken feed, copper in an amount from about 2.0 to 20 mg per kg of the supplemented chicken feed, selenium in an amount from about 0.05 to 0.30 mg per kg of the supplemented chicken feed, iodine in an amount from about 0.25 to 5.0 mg per kg of the supplemented chicken feed, iron in an amount from about 10 to 100 mg per kg of the supplemented chicken feed, manganese in an amount from about 15 to 150 mg per kg of the supplemented chicken feed, zinc in an amount from about 15 to 1500 mg per kg of the supplemented chicken feed, calcium in an amount from about 5,000 to 20,000 mg per kg of the supplemented chicken feed, sodium in an amount from about 500 to 2,500 mg per kg of the supplemented chicken feed, potassium in an amount from about 2,000 to 10,000 mg per kg of the supplemented chicken feed, phosphorus in an amount from about 1000 to 10,000 mg per kg of the supplemented chicken feed, and magnesium in an amount from about 100 to about 500 mg per kg of the supplemented chicken feed.

16. The use of claim 11, wherein the supplemented chicken feed comprises one or more minerals selected from the group consisting of cobalt in an amount from about 0.20 to 1.0 mg per kg of the supplemented chicken feed, copper in an amount from about 2.0 to 5.0 mg per kg of the supplemented chicken feed, selenium in an amount from about 0.05 to 0.2 mg per kg of the supplemented chicken feed, iodine in an amount from about 0.25 to 0.5 mg per kg of the supplemented chicken feed, iron in an amount from about 10 to 40 mg per kg of the supplemented chicken feed, manganese in an amount from about 15 to 50 mg per kg of the supplemented chicken feed, zinc in an amount from about 15 to 50 mg per kg of the supplemented chicken feed, calcium in an amount from about 5,000 to 10,000 mg per kg of the supplemented chicken feed, sodium in an amount from about 500 to 1,000 mg per kg of the supplemented chicken feed, potassium in an amount from about 2,000 to 5,000 mg per kg of the supplemented chicken feed, phosphorus in an amount from about 1000 to 4,000 mg per kg of the supplemented chicken feed, and magnesium in an amount from about 100 to about 200 mg per kg of the supplemented chicken feed.

17. The use of claim 11 or 12, wherein the supplemented chicken feed comprises one or more amino acids selected from the group consisting of alanine in an amount from about 2 to about 10 g per kg of the supplemented chicken feed, arginine in an amount from about 2 to about 10 g per kg, asparagine in an amount from about 3 to about 15 g per kg, aspartic acid in an amount from about 3 to about 15 g per kg, cysteine in an amount from about 0.5 to about 2.5 g per kg, glutamine in an amount from about 4 to about 20 g per kg, glutamic acid in an amount from about 3 to about 15 g per kg, glycine in an amount from about 2.5 to about 12 g per kg, histidine in an amount from about 0.5 to about 12 g per kg, isoleucine in an amount from about 0.6 to about 3 g per kg, lysine in an amount from about 2 to about 10 g per kg, methionine in an amount from about 1 to about 6 g per kg, phenylalanine in an amount from about 1 to about 5 g per kg, proline in an amount from about 2.5 to about 12 g per kg, serine in an amount from about 1 to about 5 g per kg, threonine in an amount from about 1 to about 5 g per kg, tryptophan in an amount from about 0.5 to about 3.5 g per kg, tyrosine in an amount from about 1 to about 5 g per kg, and valine in an amount from about 0.6 to about 3 mg per kg.

18. The use of claim 11, wherein the supplemented chicken feed comprises one or more amino acids selected from the group consisting of alanine in an amount from about 2 to about 7 g per kg of the supplemented chicken feed, arginine in an amount from about 2 to about 7 g per kg, asparagine in an amount from about 3 to about 10 g per kg, aspartic acid in an amount from about 3 to about 10 g per kg, cysteine in an amount from about 0.5 to about 2 g per kg, glutamine in an amount from about 4 to about 14 g per kg, glutamic acid in an amount from about 3 to about 10 g per kg, glycine in an amount from about 2.5 to about 8 g per kg, histidine in an amount from about 0.5 to about 1.5 g per kg, isoleucine in an amount from about 0.5 to about 2 g per kg, lysine in an amount from about 2 to about 7 g per kg, methionine in an amount from about 1.2 to about 4.2 g per kg, phenylalanine in an amount from about 1 to about 3.5 g per kg, proline in an amount from about 2.5 to about 8.5 g per kg, serine in an amount from about 1 to about 3.5 g per kg, threonine in an amount from about 1 to about 3.5 g per kg, tryptophan in an amount from about 0.5 to about 2.5 g per kg, tyrosine in an amount from about 1 to about 3.5 g per kg, and valine in an amount from about 0.5 to about 2 g per kg.

19. (canceled)
